(19) United States
(12) Patent Application Publication
(10) Pub. No.: US 2024/0357464 A1
(43) Pub. Date: Oct. 24, 2024

(54) URSP RULE MONITORING AND REPORTING METHOD AND APPARATUS, TERMINAL, AND NETWORK ELEMENT

(71) Applicant: VIVO MOBILE COMMUNICATION CO., LTD., Dongguan (CN)

(72) Inventor: Huazhang LV, Dongguan (CN)

(73) Assignee: VIVO MOBILE COMMUNICATION CO., LTD., Dongguan (CN)

(21) Appl. No.: 18/759,787

(22) Filed: Jun. 28, 2024

Related U.S. Application Data
(63) Continuation of application No. PCT/CN2022/143595, filed on Dec. 29, 2022.

(30) Foreign Application Priority Data
Dec. 30, 2021 (CN) 202111660014.2

(51) Int. Cl. H04W 40/12; H04W 60/00

(52) U.S. Cl. CPC H04W 40/12; H04W 60/00

(57) ABSTRACT

This application discloses a method for UE route selection policy (URSP) rule monitoring and reporting, a terminal, and a network element. The method includes: monitoring, by a terminal, evaluation result of a first URSP rule; and sending, by the terminal, first information according to the evaluation result, where the first URSP rule includes at least one URSP rule in URSP rules in the terminal, and one URSP rule corresponds to one rule precedence; and the first information is used to indicate at least one of the following: whether the first URSP rule is evaluated by the terminal, related information of a first application, and a first packet data unit (PDU) session that application traffic of the first application matches, where the first application is an application for which the first URSP rule in the terminal is used when the first URSP rule is evaluated by the terminal.

### CROSS-REFERENCE TO RELATED APPLICATIONS

This application is a continuation of International Application No. PCT/CN2022/143595, filed Dec. 29, 2022, which claims priority to Chinese Patent Application No. 202111660014.2, filed Dec. 30, 2021. The entire contents of each of the above-referenced applications are expressly incorporated herein by reference.

### TECHNICAL FIELD

This application relates to the field of communication technologies, and specifically relates to a UE Route Selection Policy (URSP) rule monitoring and reporting method and apparatus, a terminal, and a network element.

### BACKGROUND

In the related art, in a case that application data of an application on a terminal needs to be sent, for example, when application traffic on the terminal needs to be sent to the Internet, the terminal needs to select one PDU session in the terminal to carry the application traffic, and send the application traffic by using the PDU session. In a current method, the application provides a traffic characteristic of the to-be-sent traffic. Then, the terminal may select or create a PDU session for the application traffic according to a URSP rule delivered by a network side and the traffic characteristic of the application, to carry the application traffic. However, after the network side delivers a UE Route Selection Policy (URSP) rule, the network side cannot learn which URSP rule is selected for the application traffic, and in addition, the network side cannot learn to which Packet Data Unit (PDU) session the terminal matches the application traffic by using the URSP rule after the URSP rule is used.

In this case, the terminal and the network side have different understanding on transmission of the application traffic, and specific execution and implementation of the URSP rule in the terminal is opaque to the network side. As an operator, a terminal policy cannot be further optimized for the terminal according to an evaluation result of the specific URSP rule. Therefore, how to ensure consistency of understanding between the terminal and the network side and how to enable the network side or the operator to better optimize the terminal policy according to the evaluation result of the URSP rule fed back by the terminal is an urgent problem to be resolved.

### SUMMARY

Embodiments of this application provide a URSP rule monitoring and reporting method and apparatus, a terminal, a network element, and a medium.

According to a first aspect, a UE route selection policy URSP rule monitoring and reporting method is provided. The method includes: monitoring, by a terminal, evaluation result of a first URSP rule; and sending, by the terminal, first information according to the evaluation result, where the first URSP rule includes at least one URSP rule in URSP rules in the terminal, and one URSP rule corresponds to one rule precedence; and the first information is used to indicate at least one of the following: whether the first URSP rule is evaluated by the terminal, related information of a first application, or a first packet data unit PDU session that application traffic of the first application matches, where the first application is an application for which the first URSP rule in the terminal is used when the first URSP rule is evaluated by the terminal.

According to a second aspect, a URSP rule monitoring and reporting apparatus is provided. The apparatus includes a monitoring module and a sending module, where the monitoring module is configured to monitor evaluation result of a first URSP rule; and the sending module is configured to send first information according to the evaluation result monitored by the monitoring module, where the first URSP rule includes at least one URSP rule in URSP rules in the terminal, and one URSP rule corresponds to one rule precedence; and the first information is used to indicate at least one of the following: whether the first URSP rule is evaluated by the terminal, related information of a first application, or a first packet data unit PDU session that application traffic of the first application matches, where the first application is an application for which the first URSP rule in the terminal is used when the first URSP rule is evaluated by the terminal.

According to a third aspect, a URSP rule monitoring and reporting method is provided. The method includes: obtaining, by a policy control network element, target information; and determining, by the policy control network element according to the target information, whether a terminal executes a first URSP rule, where the first URSP rule includes at least one URSP rule in URSP rules in the terminal, and one URSP rule corresponds to one rule precedence.

According to a fourth aspect, a URSP rule monitoring and reporting apparatus is provided. The apparatus includes an obtaining module and a determining module, where the obtaining module is configured to obtain target information; and the determining module is configured to determine, according to the target information obtained by the obtaining module, whether a terminal executes a first URSP rule, where the first URSP rule includes at least one URSP rule in URSP rules in the terminal, and one URSP rule corresponds to one rule precedence.

According to a fifth aspect, a URSP rule monitoring and reporting method is provided. The method includes: sending, by a session management network element, second information to a policy control network element, where the second information includes first attribute information of a target packet data unit PDU session that carries application traffic of a terminal, and the first attribute information is used by the policy control network element to determine whether the terminal executes a first URSP rule.

According to a sixth aspect, a URSP rule monitoring and reporting apparatus is provided. The apparatus includes a sending module, where the sending module is configured to send second information to a policy control network element, where the second information includes first attribute information of a target packet data unit PDU session that carries application traffic of a terminal, and the first attribute information is used by the policy control network element to determine whether the terminal executes a first URSP rule.

According to a seventh aspect, a URSP rule monitoring and reporting method is provided. The method includes: sending, by a user plane management function network element, a target session identifier of a target packet data unit PDU session to a session management network element, where the target PDU session is used to carry a first data packet of a first application, the first data packet is a data packet detected by the user plane management function network element by using a packet detection rule, the target session identifier is used by the session management network element to determine a target PDU session that carries application traffic of a terminal and first attribute information of the target PDU session, and the first attribute information is used by a policy control network element to determine whether the terminal executes a first URSP rule.

According to an eighth aspect, a URSP rule monitoring and reporting apparatus is provided. The apparatus includes a sending module, where the sending module is configured to send a target session identifier of a target packet data unit PDU session to a session management network element, where the target PDU session is used to carry a first data packet of a first application, the first data packet is a data packet detected by a user plane management function network element by using a packet detection rule, the target session identifier is used by the session management network element to determine a target PDU session that carries application traffic of a terminal and first attribute information of the target PDU session, and the first attribute information is used by a policy control network element to determine whether the terminal executes a first URSP rule.

According to a ninth aspect, a URSP rule monitoring and reporting method is provided. The method includes: receiving, by a mobility management network element, an uplink non-access stratum NAS message sent by a terminal; and sending, by the mobility management network element, a first policy to the terminal, where the uplink NAS message carries a registration request; and the registration request includes terminal capability information, and the terminal capability information is used to indicate that the terminal has a capability of monitoring evaluation result of a URSP rule.

According to a tenth aspect, a URSP rule monitoring and reporting apparatus is provided. The apparatus includes a receiving module and a sending module, where the receiving module is configured to receive an uplink non-access stratum NAS message sent by a terminal; and the sending module is configured to send a first policy to the terminal, where the uplink NAS message carries a registration request; and the registration request includes terminal capability information, and the terminal capability information is used to indicate that the terminal has a capability of monitoring evaluation result of a URSP rule.

According to an eleventh aspect, a terminal is provided. The terminal includes a processor and a memory, the memory stores a program or an instruction that can be run on the processor, and the program or the instruction is executed by the processor to implement the steps of the method according to the first aspect.

According to a twelfth aspect, a terminal is provided, including a processor and a communication interface. The processor is configured to monitor evaluation result of a first URSP rule; and the communication interface is configured to send first information according to the evaluation result.

According to a thirteenth aspect, a policy control network element is provided. The policy control network element includes a processor and a memory, the memory stores a program or an instruction that can be run on the processor, and the program or the instruction is executed by the processor to implement the steps of the method according to the first aspect.

According to a fourteenth aspect, a policy control network element is provided, including a processor and a communication interface. The communication interface is configured to obtain target information; and the processor is configured to determine, according to the target information, whether a terminal executes a first URSP rule, where the first URSP rule includes at least one URSP rule in URSP rules in the terminal, and one URSP rule corresponds to one rule precedence.

According to a fifteenth aspect, a session management network element is provided. The session management network element includes a processor and a memory, the memory stores a program or an instruction that can be run on the processor, and the program or the instruction is executed by the processor to implement the steps of the method according to the first aspect.

According to a sixteenth aspect, a session management network element is provided, including a processor and a communication interface. The communication interface is configured to send second information to a policy control network element, where the second information includes first attribute information of a target packet data unit PDU session that carries application traffic of a terminal, and the first attribute information is used by the policy control network element to determine whether the terminal executes a first URSP rule.

According to a seventeenth aspect, a user plane management function network element is provided. The user plane management function network element includes a processor and a memory, the memory stores a program or an instruction that can be run on the processor, and the program or the instruction is executed by the processor to implement the steps of the method according to the first aspect.

According to an eighteenth aspect, a user plane management function network element is provided, including a processor and a communication interface. The communication interface is configured to send a target session identifier of a target packet data unit PDU session to a session management network element, where the target PDU session is used to carry a first data packet of a first application, the first data packet is a data packet detected by a user plane management function network element by using a packet detection rule, the target session identifier is used by the session management network element to determine a target PDU session that carries application traffic of a terminal and first attribute information of the target PDU session, and the first attribute information is used by a policy control network element to determine whether the terminal executes a first URSP rule.

According to a nineteenth aspect, a mobility management network element is provided. The mobility management network element includes a processor and a memory, the memory stores a program or an instruction that can be run on the processor, and the program or the instruction is executed by the processor to implement the steps of the method according to the first aspect.

According to a twentieth aspect, a mobility management function network element is provided, including a processor and a communication interface. The communication interface is configured to receive an uplink non-access stratum NAS message sent by a terminal; and send a first policy to the terminal, where the uplink NAS message carries a registration request; and the registration request includes terminal capability information, and the terminal capability information is used to indicate that the terminal has a capability of monitoring evaluation result of a URSP rule.

According to a twenty-first aspect, a readable storage medium is provided. The readable storage medium stores a program or an instruction, and the program or the instruction is executed by a processor to implement the steps of the method according to the first aspect, or the steps of the method according to the third aspect, or the steps of the method according to the fifth aspect, or the steps of the method according to the seventh aspect, or the steps of the method according to the ninth aspect.

According to a twenty-second aspect, a chip is provided. The chip includes a processor and a communication interface, the communication interface is coupled to the processor, and the processor is configured to run a program or an instruction to implement the steps of the method according to the first aspect, or the steps of the method according to the third aspect, or the steps of the method according to the fifth aspect, or the steps of the method according to the seventh aspect, or the steps of the method according to the ninth aspect.

According to a twenty-third aspect, a computer program/program product is provided. The computer program/program product is stored in a storage medium, and the computer program/program product is executed by at least one processor to implement the steps of the method according to the first aspect, or the steps of the method according to the third aspect, or the steps of the method according to the fifth aspect, or the steps of the method according to the seventh aspect, or the steps of the method according to the ninth aspect.

In the embodiments of this application, a terminal monitors evaluation result of a first URSP rule, and sends first information according to the evaluation result, where the first URSP rule includes at least one URSP rule in URSP rules in the terminal, and one URSP rule corresponds to one rule precedence; and the first information is used to indicate at least one of the following: whether the first URSP rule is evaluated by the terminal, related information of a first application, or a first packet data unit PDU session that application traffic of the first application matches, where the first application is an application for which the first URSP rule in the terminal is used when the first URSP rule is evaluated by the terminal. In this method, the terminal may report the first information, to indicate whether the terminal executes the first URSP rule and a finally determined PDU session used to carry application traffic on the terminal. In this way, consistency of understanding between a terminal and a network side is ensured, thereby improving network reliability.

### BRIEF DESCRIPTION OF DRAWINGS

FIG. 1 is a possible schematic architecture diagram of a communication system according to an embodiment of this application;

FIG. 2 is a first schematic flowchart of a URSP rule monitoring and reporting method according to an embodiment of this application;

FIG. 3 is a second schematic flowchart of a URSP rule monitoring and reporting method according to an embodiment of this application;

FIG. 4 is a third schematic flowchart of a URSP rule monitoring and reporting method according to an embodiment of this application;

FIG. 5 is a fourth schematic flowchart of a URSP rule monitoring and reporting method according to an embodiment of this application;

FIG. 6 is a fifth schematic flowchart of a URSP rule monitoring and reporting method according to an embodiment of this application;

FIG. 7 is a sixth schematic flowchart of a URSP rule monitoring and reporting method according to an embodiment of this application;

FIG. 8 is a seventh schematic flowchart of a URSP rule monitoring and reporting method according to an embodiment of this application;

FIG. 9 is an eighth schematic flowchart of a URSP rule monitoring and reporting method according to an embodiment of this application;

FIG. 10 is a first schematic structural diagram of a URSP rule monitoring and reporting apparatus according to an embodiment of this application;

FIG. 11 is a second schematic structural diagram of a URSP rule monitoring and reporting apparatus according to an embodiment of this application;

FIG. 12 is a third schematic structural diagram of a URSP rule monitoring and reporting apparatus according to an embodiment of this application;

FIG. 13 is a fourth schematic structural diagram of a URSP rule monitoring and reporting apparatus according to an embodiment of this application;

FIG. 14 is a fifth schematic structural diagram of a URSP rule monitoring and reporting apparatus according to an embodiment of this application;

FIG. 15 is a schematic structural diagram of a communication device according to an embodiment of this application;

FIG. 16 is a schematic structural diagram of a terminal according to an embodiment of this application;

FIG. 17 is a first structural schematic diagram of a network side device according to an embodiment of this application; and

FIG. 18 is a second schematic structural diagram of a network side device according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill based on the embodiments of this application shall fall within the protection scope of this application.

In the specification and claims of this application, the terms “first”, “second”, and the like are intended to distinguish between similar objects but do not describe a specific order or sequence. It should be understood that the terms used in such a way are interchangeable in proper circumstances so that the embodiments of this application can be implemented in orders other than the order illustrated or described herein. Objects classified by “first” and “second” are usually of a same type, and the number of objects is not limited. For example, there may be one or more first objects. In addition, in the specification and claims, “and/or” represents at least one of connected objects, and a character “/” generally represents an “or” relationship between associated objects.

It should be noted that technologies described in the embodiments of this application are not limited to a Long Time Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and other systems. The terms “system” and “network” in the embodiments of this application may be used interchangeably. The technologies described can be applied to both the systems and the radio technologies mentioned above as well as to other systems and radio technologies. The following describes a New Radio (NR) system for example purposes, and NR terms are used in most of the following descriptions. These technologies can also be applied to applications other than an NR system application, such as a 6th generation (6G) communication system.

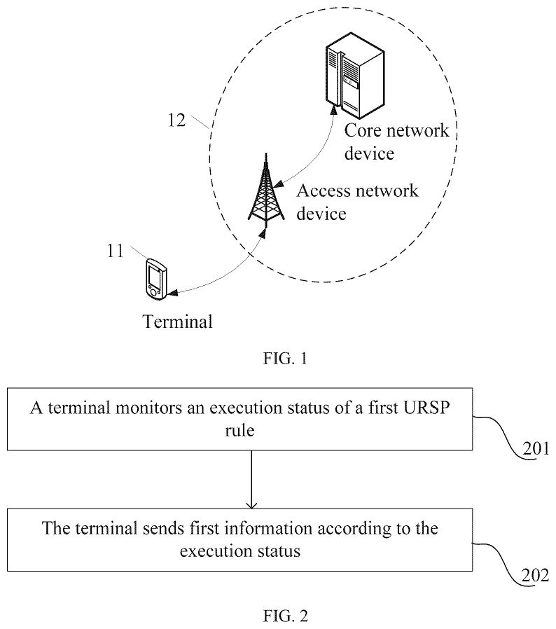

FIG. 1 is a block diagram of a wireless communication system to which the embodiments of this application can be applied. The wireless communication system includes a terminal 11 and a network side device 12. The terminal 11 may be a terminal side device such as a mobile phone, a tablet personal computer, a laptop computer or a notebook computer, a personal digital assistant (PDA), a palmtop computer, a netbook, an ultra-mobile personal computer (UMPC), a mobile internet device (MID), an augmented reality (AR)/virtual reality (VR) device, a robot, a wearable device, vehicle user equipment (VUE), pedestrian user equipment (PUE), a smart home (a home device with a wireless communication function, such as a refrigerator, a television, a washing machine, or a furniture), a game console, a personal computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, and a smart chain), a smart wrist strap, a smart dress, and the like. It should be noted that a specific type of the terminal 11 is not limited in the embodiments of this application. The network side device 12 may include an access network device or a core network device. The access network device 12 may also be referred to as a radio access network device, a Radio Access Network (RAN), a radio access network function, or a radio access network unit. The access network device 12 may include a base station, a WLAN access point, a Wi-Fi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmitting Receiving Point (TRP), or another appropriate term in the field. As long as a same technical effect is achieved, the base station is not limited to a specified technical term. It should be noted that, in this application, only a base station in an NR system is used as an example, and a specific type of the base station is not limited. The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF), an Edge Application Server Discovery Function (EASDF), Unified Data Management (UDM), a Unified Data Repository (UDR), a Home Subscriber Server (HSS), a Centralized network configuration (CNC), a Network Repository Function (NRF), a Network Exposure Function (NEF), a local NEF (L-NEF), a Binding Support Function (BSF), an Application Function (AF), or the like. It should be noted that, in the embodiments of this application, only a core network device in an NR system is used as an example for description, and a specific type of the core network device is not limited.

The following describes some professional terms in the embodiments of this application.

1. UE Route Selection Policy (URSP) rules: The URSP rules are a policy that is sent by a terminal and that is defined in 3GPP, and the terminal matches traffic of an application (APP) to a specific Packet Data Unit (PDU) session according to the URSP rules. That is, the terminal selects or establishes, by using the URSP rule according to a characteristic of a data flow of the application, a PDU session to carry the traffic of the application.

For example, URSP rules include a plurality of URSP rules with different rule precedence. One URSP rule corresponding to one rule precedence includes at least one traffic descriptor (TD), and each traffic descriptor includes a plurality of route selection descriptors (RSD).

Therefore, for a to-be-sent data flow of the application, the terminal first selects a traffic descriptor according to a characteristic of the application traffic, where the traffic descriptor matches the characteristic of the application traffic. Then, the terminal selects or creates, by using an RSD in the traffic descriptor, a PDU session to carry the application traffic, where a session attribute or a session parameter of the PDU session in the RSD is included.

2. A Traffic Descriptor (TD) is also referred to as a service descriptor, a network traffic descriptor, a traffic description, or a traffic characteristic. The terminal matches or identifies a characteristic of APP traffic by using a traffic descriptor, and the terminal selects an RSD in the case of the traffic descriptor according to the characteristic of the application traffic. There are many types of traffic descriptor parameters, for example, including a destination Internet Protocol (IP) address, a Fully Qualified Domain Name (FQDN), and the like. The specific descriptions are as follows:

For example, when traffic of an APP on the terminal needs to be sent to a server, the APP may send an APP traffic characteristic parameter to the terminal, and then the terminal matches traffic description parameters in URSP rules of the terminal one by one according to the APP traffic characteristic parameter.

A group of traffic descriptor parameters are specified in the URSP rules. This group of traffic descriptor parameters are as follows:
(a) application descriptors;
(b) IP descriptors;
(c) domain descriptors, such as a fully qualified domain name FQDN;
(d) non-IP descriptors;
(e) a Data Network Name (DNN); and
(f) connection capabilities, such as Internet and IMS.

Each traffic descriptor parameter in this group of traffic descriptor parameters includes a preconfigured group of parameter information. For example, IP descriptors in the traffic descriptor is used as an example, and the IP descriptors may include a group of parameter information of a destination IP=10.1.1.1 and a port number=80.

Definitions of a group of traffic descriptor parameters specified in the foregoing URSP rules are shown in Table 1.

TABLE 1

| Information name | Description |
|---|---|
| Rule precedence | Precedence of a URSP rule in UE |
| Traffic descriptor | |
| Application descriptors | Including OSId and OSAppId(s) |
| IP descriptors | Destination IP triplet: IP address or IPv6 |
| | network prefix, port number, and protocol |
| Domain descriptors | FQDN(s) Fully qualified domain name |
| Non-IP descriptors | Non-IP traffic description |
| DNN | This matches DNN information provided by |
| | an application. |
| Connection capabilities | This matches information provided by a |
| | UE application when requesting a network |
| | connection with some functions. (Note 4) |
| List of route selection | List of RSDs contained in the traffic |
| descriptors | descriptor |

For example, for a to-be-sent application data flow of an APP on the terminal, the application expects to send the application data flow to a server address of a destination IP=10.1.1.1 and a port number=80. If a traffic descriptor parameter in the URSP rules of the terminal includes IP descriptor parameters of the destination IP=10.1.1.1 of the receive end and the port number=80, it indicates that a characteristic of the application data flow of the APP may be matched by the traffic descriptor in the URSP rule, that is, the traffic that needs to be sent may match a URSP rule of the terminal. After the matching is completed, the terminal may select an RSD in the case of the traffic descriptor to determine a PDU session to carry the application traffic.

It should be noted that, APP traffic, that is, APP traffic is also referred to as an APP service flow, an APP communication flow, or an application data flow.

3. A Route Selection Descriptor (RSD) is used to describe or select a PDU session attribute or a PDU session parameter that carries application data, including parameters such as Single Network Slice Selection Assistance Information (S-NSSAI) and a DNN. See Table 2 below:

TABLE 2

| Information name | Description |
|---|---|
| Route selection | Determine a precedence order of RSDs |
| descriptor precedence | |
| RSD precedence | |
| Route selection | This part defines the route selection |
| components | components |
| SSC mode selection | SSC modes are classified into an SSC mode |
| SSC mode | 1, an SSC mode 2 and an SSC mode 3. |
| Slice selection | Including a single S-NSSAI (s) value or |
| Network slice | an S-NSSAI list |
| selection | |
| DNN selection | A single value or a value list of DNN(s) |
| PDU session type | PDU session type |
| selection | |
| PDU session type | |
| Access Type | Preferred access type (3GPP or non-3GPP or |
| preference | multi-access) when the terminal establishes |
| | a PDU session for a matched application. |

For example, the terminal first selects a traffic descriptor according to a characteristic of to-be-sent traffic of an APP, and then the terminal determines an attribute or a parameter of a PDU session that carries the application traffic, that is, the terminal further needs to select an RSD in a traffic descriptor, and determines, according to the RSD, a PDU session that carries or sends the APP traffic, or the terminal creates a PDU session by using a PDU session parameter in the RSD.

Generally, there may be a plurality of RSDs in one traffic descriptor parameter. Each RSD has different precedence, and each RSD represents a group of attributes of one PDU session. For example, after the APP traffic matches a traffic descriptor of a destination IP=10.1.1.1 and a port number=80, the traffic descriptor may include a plurality of RSDs.

For example, an attribute of an RSD may include at least one of the following: an RSD precedence, a network slice selection, a data network name (DNN) selection, an access type preference, a PDU session type, or the like.

For example, the following lists RSD attribute information of two RSDs of different attributes.
(1) RSD precedence=1
   Network Slice Selection: S-NSSAI-a
   Access Type preference: Non-3GPP Access
(2) RSD precedence=2
   Network Slice Selection: S-NSSAI-a
   Access Type preference: 3GPP Access
   DNN=Internet
   SSC mode=3

For example, after the terminal selects and determines, according to URSP rules, that an RSD is an RSD 1 (RSD precedence=1 is abbreviated as RSD 1 below) for the application traffic, a characteristic of a PDU session corresponding to the RSD 1 is S-NSSAI=S-NSSAI-a, and non-3GPP access is performed. In this case, the terminal carries the application traffic of the application by using a PDU session in the terminal, and a session parameter of the PDU session is: slice S-NSSAI-a is used, and non-3GPP access is performed.

In the related art, after the network sends the URSP rules to the UE, the following two cases may exist:

Case 1: For a to-be-sent application data flow on the terminal, whether the terminal uses URSP rules and which URSP rule is used by the terminal to match APP traffic to a specific PDU session need to be determined, that is, the network side needs to know whether the UE executes the URSP rules.

Case 2: After the terminal matches the APP traffic to a corresponding traffic descriptor by using the URSP rules, the terminal needs to select an RSD, that is, select a specific PDU session to carry the application traffic. However, the traffic descriptor includes a plurality of RSDs, that is, for the APP traffic that has matched the traffic descriptor, two PDU sessions respectively corresponding to an RSD 1 and an RSD 2 may be optional. In addition, the terminal may not need to select or create a PDU session strictly according to a PDU session parameter or attribute in the RSD. For example, the terminal selects the RSD 1 in the traffic descriptor, where a parameter included in the RSD 1 is: S-NSSAI=S-NSSAI-a, and non-3GPP access is performed. However, an attribute or a parameter of a PDU session that ultimately carries the application data flow is: S-NSSAI=S-NSSAI-a, and 3GPP access is performed. This indicates that the terminal does not select or create a PDU session strictly according to the PDU session parameter in the RSD. Therefore, the network side cannot learn which RSD the terminal finally selects to determine a PDU session that carries the APP traffic, and does not know whether the terminal really strictly select a PDU session or creates a PDU session according to the RSD, and therefore the network side cannot learn which PDU session is ultimately used to carry the APP traffic.

In this case, the terminal and the network side device have different understanding on transmission of APP traffic. Therefore, how to ensure consistency of understanding between the terminal and the network side becomes an urgent problem to be resolved.

With reference to the accompanying drawings, the following describes in detail a URSP rule monitoring and reporting method provided in the embodiments of this application by using some embodiments and application scenarios thereof.

An embodiment of this application provides a URSP rule monitoring and reporting method. As shown in FIG. 2, the method includes the following steps 201 and 202.

Step 201: A terminal monitors evaluation result of a first URSP rule.

The first URSP rule includes at least one URSP rule in URSP rules in the terminal, and one URSP rule corresponds to one rule precedence.

In this embodiment of this application, the URSP rule in the terminal may be a URSP rule sent by a network side to the terminal.

In this embodiment of this application, the first URSP rule is a URSP rule that the network side indicates that the terminal needs to monitor.

In this embodiment of this application, the first URSP rule includes at least one of the following:
a URSP rule corresponding to a first rule precedence in a plurality of URSP rules in the terminal;
a first traffic descriptor in the first rule precedence; or
a first route selection descriptor in the first rule precedence, where
the first rule precedence includes at least one rule precedence, and the first route selection descriptor includes at least one route selection descriptor in the first traffic descriptor.

For example, the first rule precedence may be a rule precedence 1 or 2, or may be any rule precedence indicated by the network side. This is not limited in this embodiment of this application.

For example, according to a traffic characteristic of application traffic of a terminal, for example, a traffic characteristic of an APP is: being sent to a destination IP address=server 10.1.1.1, and that the terminal may monitor a URSP rule is any one of the following cases:
the terminal monitors evaluation result of URSP rules corresponding to all precedence;
the terminal monitors evaluation result of a rule whose rule precedence is 1;
the terminal monitors evaluation result of traffic descriptor=IP descriptors (for example, destination IP=10.1.1.1) in the case of rule precedence=1;
the terminal monitors evaluation result of RSD precedence=1 (for example, RSD precedence=1, corresponding S-NSSAI=S-NSSAI-a, and non-3GPP is used for access) in the case of traffic descriptor=IP descriptors (for example, destination IP=10.1.1.1); or
the terminal may directly monitor a traffic descriptor, or directly monitor evaluation result of an RSD in an RSD precedence.

Step 202: The terminal sends first information according to the evaluation result.

The first information is used to indicate at least one of the following: whether the first URSP rule is evaluated by the terminal, related information of a first application, or a first packet data unit PDU session that application traffic of the first application matches, where the application traffic of the first application is application traffic for which the first URSP rule is used when the first URSP rule is evaluated by the terminal.

In this embodiment of this application, the terminal sends the first information to a network side device according to the evaluation result.

In some embodiments, the network side device receives the first information, and updates a URSP rule of the terminal according to the evaluation result of the first URSP rule, or changes a PDU session or PDU session information that carries the application traffic of the first application on the terminal.

In some embodiments, the network side device may be a policy control network element.

In an implementation, the terminal uses the first URSP rule for the first application traffic, and reports the first information according to the evaluation result of the first URSP rule.

In this embodiment of this application, the related information includes at least a traffic characteristic of the application traffic of the first application.

For example, the traffic characteristic of the first application includes at least one of the following: a traffic descriptor of the application traffic, a destination IP triplet to which the application traffic is sent, a fully qualified domain name FQDN of the application traffic, a data network name DNN to which the application traffic is sent, a connection capability of the application traffic, or an application descriptor of the application traffic (including OSId and OSAppId(s)).

In this embodiment of this application, the first information includes at least one of the following:
traffic description information of the application traffic;
a URSP rule executed by the terminal;
a traffic descriptor selected by the terminal;
a route selection descriptor selected by the terminal;
a precedence of the traffic descriptor selected by the terminal;
a precedence of the route selection descriptor selected by the terminal;
a rule precedence selected by the terminal; or
PDU session information of a PDU session that carries the application traffic, where
the PDU session information includes at least one of the following: a session and service continuity mode, a data network name, a connection capability, single network slice selection assistance information, a PDU session type, an access type preference, or a PDU session identity (ID).

In some embodiments, the PDU session information of the PDU session that carries the application traffic is used to describe a session attribute and/or a session parameter of the PDU session.

In some examples, the PDU session information may be a PDU session attribute or a PDU session parameter.

In a case that the first information includes the traffic description information of the application traffic, the traffic description information of the application traffic may include at least one of the following: a traffic descriptor of the application traffic, a destination IP triple of the application traffic, a fully qualified domain name FQDN of the application traffic, a data network name DNN of the application traffic, or a connection capability of the application traffic. It should be noted that the traffic description information of the application traffic may also be understood as a traffic characteristic of the application traffic.

In a case that the first information includes the URSP rule evaluated by the terminal, the URSP rule evaluated by the terminal may be a URSP rule used by the terminal when matching is performed on the application traffic of the first application.

In a case that the first information includes the traffic descriptor selected by the terminal, the traffic descriptor selected by the terminal may be a traffic descriptor actually selected when the terminal matches the application traffic of the first application by using the first URSP rule.

In a case that the first information includes the route selection descriptor selected by the terminal, the route selection descriptor selected by the terminal may be a route selection descriptor actually selected when the terminal matches the application traffic of the first application by using the first URSP rule.

In a case that the first information includes the PDU session that carries the application traffic, the PDU session that carries the application traffic may be a PDU session that is actually matched or created based on the traffic characteristic of the application traffic when the terminal matches the application traffic of the first application by using the first URSP rule.

It should be understood that, in a case that the terminal matches the application traffic by using the first URSP rule, a session attribute of a PDU session that is finally actually established or matched by the terminal for the application traffic may be inconsistent with an RSD in the first URSP rule. Therefore, the terminal may monitor and report an execution result, so that the network side can determine, according to the execution result, whether the terminal correctly executes the first URSP rule, that is, whether the application traffic is matched to the correct PDU session.

For example, the first application is an APP 1. When receiving application traffic of the APP 1, the terminal matches the application traffic of the APP 1 by using URSP rules sent by the network side, to match the application traffic to a proper PDU session for transmission. The terminal reports evaluation results of the URSP rules according to the monitored URSP rules indicated by the network side, that is, to select a proper PDU session to carry the traffic of the APP 1, the terminal reports an RSD in a finally selected traffic descriptor to the network side.

Example 1: For example, the first URSP rule monitored by the terminal is a URSP rule whose rule precedence is 1 and that is delivered by the network side. When the terminal matches the application traffic (APP traffic) by using the URSP rule with the precedence 1, the terminal sends the first information to the network side according to evaluation result of the URSP rule with the precedence 1. The first information may include: the URSP rule with the precedence 1 used by the terminal, a traffic characteristic (that is, traffic description information) of the application traffic of the APP 1, a routing selection descriptor selected by the terminal according to the traffic characteristic of the application traffic, an RSD selected by the terminal according to the traffic characteristic of the application traffic (that is, a PDU session that ultimately carries the application traffic, and the like), a PDU session or a PDU session parameter that ultimately carries the application traffic, and the like.

Example 2: For example, the first URSP rule monitored by the terminal is a traffic descriptor, where the traffic descriptor is an application descriptor (APP descriptor). In a case that the terminal matches the application traffic on the terminal by using a traffic descriptor whose application descriptor is APP 2 (in this case, a traffic characteristic of the application data packet is application descriptor=APP 2), the terminal sends the first information to the network side according to evaluation result of the traffic descriptor whose application descriptor is APP 2. The first information may include a traffic descriptor used by the terminal (that is, the application descriptor APP 2), a traffic characteristic of the application traffic on the terminal, a route selection descriptor selected by the terminal according to the traffic characteristic of the application traffic of the APP 2, a session PDU or a PDU session parameter that finally carries the application traffic of the terminal.

Example 3: For example, in the first URSP rule monitored by the terminal, a traffic descriptor is a route selection descriptor whose route selection descriptor precedence (RSD Precedence) is equal to 1 in a case that an application descriptor is APP 3. After the terminal uses the traffic descriptor, the terminal sends the first information to the network side according to evaluation result of the route selection descriptor. The first information may include: the route selection descriptor whose route selection descriptor precedence is equal to 1 used by the terminal, a precedence of the route selection descriptor used by the terminal, a traffic characteristic of the application traffic, a PDU session or a PDU session parameter that finally carries the application traffic, and the like.

It should be understood that the route selection descriptor whose route selection descriptor precedence is equal to 1 may be: in a URSP rule whose rule precedence is equal to 6, an RSD whose RSD precedence is equal to 1 in a traffic descriptor whose application descriptor is equal to App 3. As described in the following Table 3:

TABLE 3

| | |
|---|---|
| Rule Precedence = 6 | Route Selection Descriptor Precedence = 1 |
| Traffic Descriptor: | Network Slice Selection: S-NSSAI-a |
| Application Descriptor = | SSC Mode Selection: SSC Mode 3 |
| App 3 | DNN Selection: Internet |
| | Access Type Preference: 3GPP access |

In the URSP rule monitoring and reporting method provided in this embodiment of this application, a terminal monitors evaluation result of a first URSP rule, and sends first information according to the evaluation result, where the first URSP rule includes at least one URSP rule in URSP rules in the terminal, and one URSP rule corresponds to one rule precedence; and the first information is used to indicate at least one of the following: whether the first URSP rule is evaluated by the terminal, related information of a first application, or a first packet data unit PDU session that application traffic of the first application matches, where the first application is an application for which the first URSP rule in the terminal is used when the first URSP rule is evaluated by the terminal. In this method, the terminal may report the first information, to indicate whether the terminal executes the first URSP rule and a finally determined PDU session used to carry application traffic on the terminal. In this way, consistency of understanding between a terminal and a network side is ensured, thereby improving network reliability.

In this embodiment of this application, the foregoing step 202 may include the following step 202a.

Step 202a: The terminal sends the first information to a first network element according to the evaluation result.

The first network element includes at least a mobility management network element or a policy control network element.

For example, the terminal may send the first information to the mobility management network element, and the mobility management network element sends the first information to the policy control network element, or the terminal may directly send the first information to the policy control network element.

In this embodiment of this application, before the foregoing step 201, the URSP rule reporting and monitoring method provided in this embodiment of this application further includes the following step A1 and step A2.

Step A1: In a case that the application traffic of the first application in the terminal needs to be sent, the terminal matches the application traffic according to the first URSP rule, and selects a proper PDU session to send the application traffic.

Step A2: The terminal matches the application traffic to a first PDU session, or establishes a second PDU session that matches the application traffic.

In some embodiments, with reference to the foregoing step A1 and step A2, the foregoing step 201 may include the following step 201a.

Step 201a: After the terminal matches the application traffic to the first PDU session or establishes the second PDU session that matches the application traffic, the terminal sends the first information according to the evaluation result.

In some embodiments, the first application may be any application whose application traffic needs to be sent in the terminal. The application traffic is application data or an application data packet that needs to be sent in the first application.

In some embodiments, the first PDU session is a PDU session established before the terminal executes the first URSP rule, and the first PDU session matches the application traffic of the first application. The second PDU session is a PDU session that is newly created by the terminal and that matches application traffic.

For example, a session attribute of the first PDU session may be consistent with a route selection descriptor RSD in the first URSP rule, or may be inconsistent with a route selection descriptor in the first URSP rule. A session attribute of the second PDU session may be consistent with a route selection descriptor RSD in the first URSP rule, or may be inconsistent with a route selection descriptor in the first URSP rule.

For example, the first URSP rule is a traffic descriptor whose application descriptor is equal to APP 4. In a case that an application data packet (a traffic characteristic of the application data packet is application descriptor=APP 4) in the terminal needs to be sent, the terminal matches the application traffic according to the traffic descriptor whose application descriptor is APP 4, selects an RSD precedence=1 in the case of application descriptor=APP 4, and matches the application traffic to a PDU session 2. A data network name DNN of the PDU session 2 is Internet, and a network slice type of the PDU session 2 is S-NSSAI-a. However, a data network name of an RSD in a traffic descriptor that is selected by the UE for the application traffic and whose application descriptor is APP 4 is DNN_1, and a network slice type is S-NSSAI-c, that is, the two are inconsistent. This indicates that although the terminal selects a PDU session whose RSD precedence=1 in the case of application descriptor=APP 4 for the application traffic, parameters or attributes of the PDU session in RSD precedence=1 are inconsistent with parameters or attributes of the PDU session that actually carries the application traffic. This indicates that although the terminal selects a specified URSP rule, the terminal does not strictly select or create a PDU session according to the URSP rule to carry the application traffic for some reason. Then the terminal may report, to the network side by using the first information, evaluation result of the traffic descriptor whose application descriptor is APP 4.

In this embodiment of this application, before the foregoing step 201, the URSP rule monitoring and reporting method provided in this embodiment of this application further includes the following step B1.

Step B1: The terminal receives a first policy sent by a first network element.

The first network element includes at least a mobility management network element or a policy control network element.

In some embodiments, with reference to the foregoing step B1, the foregoing step 201 may include the following step 201b.

Step 201b: The terminal determines the first URSP rule according to the first policy, and monitors the evaluation result of the first URSP rule.

In some embodiments, the first policy may be a terminal policy (UE policy) that is transparently transmitted by the mobility management network element to the terminal.

In some embodiments, the first policy may be carried in a terminal policy container. The terminal policy container includes a policy selection list (policy section list), a URSP rule precedence that needs to be monitored by the terminal, a route selection descriptor RSD, a traffic descriptor, and the like.

In some embodiments, the first policy is used to indicate at least one of the following:
a URSP rule that needs to be monitored by the terminal;
a URSP rule corresponding to a first rule precedence that needs to be monitored by the terminal;
a first traffic descriptor that needs to be monitored by the terminal; or
a first route selection descriptor that needs to be monitored by the terminal.

In some embodiments, the first traffic descriptor is a traffic descriptor in the first rule precedence, and the first route selection descriptor is a route selection descriptor in the first rule precedence. The first rule precedence includes at least one rule precedence.

For example, the first rule precedence is a URSP rule whose rule precedence is equal to 1 in URSP rules in the terminal, the first traffic descriptor is a traffic descriptor whose application descriptor is equal to App 1 in the URSP rule whose rule precedence is equal to 1, and the route selection descriptor is an RSD whose route selection descriptor precedence is equal to precedence 1 in the traffic descriptor whose application descriptor is equal to App 1.

In this embodiment of this application, before the foregoing step 201, the URSP rule monitoring and reporting method provided in this embodiment of this application further includes the following step C1.

Step C1: The terminal sends a registration request to a second network element by using an uplink non-access stratum NAS message.

The second network element includes at least a mobility management network element, and the registration request is used to request to deliver a first policy.

In some embodiments, the registration request includes terminal capability information, and the terminal capability information is used to indicate that the terminal has a capability of monitoring or reporting evaluation result of a URSP rule. Generally, only after receiving the capability information of the terminal, the network side may allow the terminal to monitor a URSP rule or allow the terminal to report URSP rule enforcement.

In some embodiments, the registration request includes a terminal policy container (UE policy container), and the terminal policy container includes terminal capability information. That is, the terminal may indicate the network side by using the terminal capability information, and the terminal may monitor and report enforcements of URSP rules.

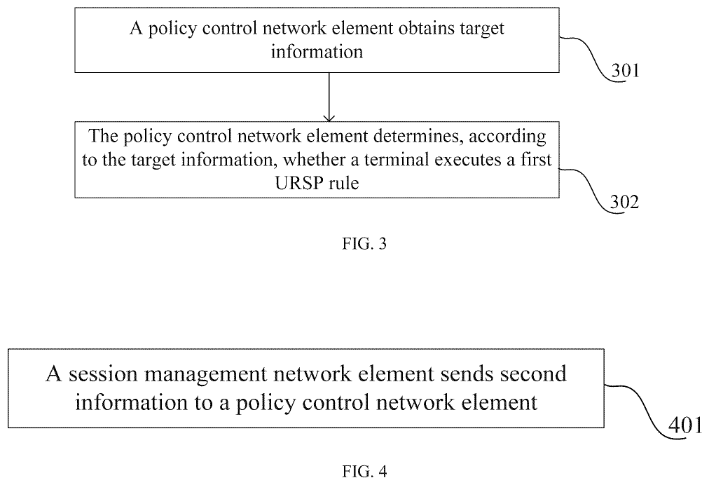

An embodiment of this application provides a URSP rule monitoring and reporting method. As shown in FIG. 3, the method includes the following steps 301 and 302.

Step 301: A policy control network element obtains target information.

In this embodiment of this application, the target information includes at least one of the following: first information sent by a terminal, or second information sent by a session management network element.

The first information is used to indicate at least one of the following: whether a first URSP rule is evaluated by the terminal, related information of a first application, or a target packet data unit PDU session that application traffic of the first application matches, where the application traffic of the first application is application traffic for which the first URSP rule in the terminal is used when the first URSP rule is evaluated by the terminal; and the second information includes first attribute information of a target packet data unit PDU session that carries application traffic of the terminal.

In this embodiment of this application, the related information that is of the first application and that is indicated by the first information includes at least a traffic characteristic of the application traffic of the first application.

The traffic characteristic includes at least one of the following: a traffic descriptor of the application traffic, a destination IP triplet to which the application traffic is sent, a fully qualified domain name FQDN of the application traffic, a data network name DNN to which the application traffic is sent, or a connection capability of the application traffic.

In this embodiment of this application, the first information includes at least one of the following:
traffic description information of application traffic of the terminal;
a URSP rule evaluated by the terminal;
a traffic descriptor selected by the terminal;
a selected route selection descriptor;
a precedence of the traffic descriptor selected by the terminal;
a precedence of the route selection descriptor selected by the terminal;
a rule precedence selected by the terminal; or
PDU session information of a PDU session that carries the application traffic of the terminal, where
the PDU session information includes at least one of the following: a session and service continuity mode, a data network name, a connection capability, single network slice selection assistance information, a PDU session type, an access type preference, or a PDU session identity ID.

In some embodiments, the PDU session information of the PDU session that carries the application traffic is used to describe a session attribute and/or a session parameter of the PDU session.

In an example, the PDU session information may be a PDU session attribute or a PDU session parameter.

In this embodiment of this application, the first attribute information includes at least one of the following: a session and service continuity mode, a data network name, a connection capability, single network slice selection assistance information, a PDU session type, an access type preference, a PDU session ID, a destination Internet Protocol IP triplet, a fully qualified domain name FQDN, or a uniform resource locator URL.

For example, in a case that the target information includes the first information, the terminal sends the first information to the policy control network element by using an uplink NAS message, the policy control network element receives the first information sent by the terminal, or the terminal sends the first information to the mobility management network element by using an uplink NAS message, the mobility management network element forwards evaluation result of the first URSP rule to the policy control network element by using an NAS message, and the policy control network element receives the first information sent by the mobility management network element.

For example, in a case that the target information includes the second information, the session management network element sends the second information to the policy control network element by using control plane signaling, and the policy control network element receives the second information sent by the session management network element. The control plane signaling herein may be service signaling provided by a session management network element, or may be service signaling provided by the policy control network element.

Step 302: The policy control network element determines, according to the target information, whether a terminal executes a first URSP rule.

The first URSP rule includes at least one URSP rule in URSP rules in the terminal, and one URSP rule corresponds to one rule precedence.

It should be understood that whether the terminal executes the first URSP rule means whether, in a case that the terminal matches the application traffic of the first application by using the first URSP rule, the terminal matches the application traffic of the first application to a correct PDU session, or establishes a correct PDU session for the application traffic of the first application, that is, whether a session attribute of the PDU session finally matched by the terminal for the application traffic or the created PDU session is consistent with an attribute (for example, a DNN, SSC mode selection, and an access type preference) of an RSD according to the first URSP rule.

In some embodiments, the policy control network element receives the first information, and updates a URSP rule of the terminal according to the evaluation result of the first URSP rule, or changes a PDU session or PDU session information that carries the application traffic of the first application in the terminal.

In the URSP rule monitoring and reporting method provided in this embodiment of this application, the policy control network element may obtain the session attribute information of the PDU session that is matched by the terminal for the application traffic of the first application by using the first URSP rule or that is created, and then determine, based on the session attribute of the PDU session, whether the terminal executes the first URSP rule, to ensure consistency of understanding between a terminal and a network side.

In this embodiment of this application, the foregoing step 302 may include at least one of step 302a and step 302b.

Step 302a: In a case that the target information meets a first condition, the policy control network element determines that the terminal executes the first URSP rule.

Step 302b: In a case that the target information meets a second condition, the policy control network element determines that the terminal does not execute the first URSP rule.

In some embodiments, that the target information meets a first condition includes at least one of the following:

Case 1: The related information that is of the first application and that is indicated by the first information matches a second traffic descriptor in the first URSP rule (and this information is reported to the PCF by using the first information), or the first attribute information of the target PDU session that carries the application traffic of the first application matches at least one route selection descriptor in the second traffic descriptor.

Case 2: The first attribute information of the target PDU session that carries the application traffic of the first application in the second information matches at least one route selection descriptor in at least one traffic descriptor in the first URSP rule.

The second traffic descriptor is any traffic descriptor in the first URSP rule.

Further, in a case that the target information meets the first condition, the first URSP rule evaluated by the terminal includes at least one of the following:
any route selection descriptor in the second traffic descriptor, where the second traffic descriptor matches the related information of the first application, and the any route selection descriptor matches the first attribute information of the target PDU session;
a traffic descriptor including the at least one route selection descriptor; or
a URSP rule including the at least one route selection descriptor.

For example, if that the target information meets the first condition is the foregoing first case, the first URSP rule evaluated by the terminal is any route selection descriptor corresponding to a second traffic descriptor, where the second traffic descriptor matches the related information of the first application, and the any routing descriptor matches the first attribute information of the target PDU session.

For example, if that the target information meets the first condition is the foregoing second case, the first URSP rule evaluated by the terminal is a traffic descriptor including the at least one route selection descriptor, or a URSP rule including the at least one route selection descriptor.

In some embodiments, that the target information meets a second condition includes at least one of the following:

Case 3: The related information that is of the first application and that is indicated by the first information does not match a second traffic descriptor in the first URSP rule, or the related information that is of the first application and that is indicated by the first application matches a second traffic descriptor in the first URSP rule, and the first attribute information of the target PDU session that carries the application traffic does not match all route selection descriptors in the second traffic descriptor.

Case 4: The first attribute information of the target PDU session that carries the application traffic in the second information does not match any route selection descriptor in any traffic descriptor in the first URSP rule.

The third case and the fourth case indicate that when a session attribute or a session parameter of a PDU session that carries a target application is inconsistent with a URSP rule monitored by the terminal or a PDU session parameter or a session attribute described by an RSD in any one of URSP rules in the terminal, the network side determines that the terminal does not correctly execute the URSP rule.

In this embodiment of this application, in a case that it is determined that the terminal does not execute the first URSP rule, the URSP rule monitoring and reporting method provided in this embodiment of this application further includes the following step 303al.

Step 303al: The policy control network element sends a first request to a session management network element.

The first request is used to request at least one of the following: releasing a PDU session that carries application traffic, or establishing a new PDU session to carry the application traffic.

A session attribute of the new PDU session is consistent with a PDU session attribute included in a route selection descriptor in a second traffic descriptor in the first URSP rule, where the second traffic descriptor is any traffic descriptor in the first URSP rule, and the second traffic descriptor matches the related information of the first application.

In some embodiments, the first request carries at least one of the following:
a terminal user permanent identifier;
a PDU session ID of a PDU session that carries application traffic; or
a traffic descriptor or a route selection descriptor in the first URSP rule.

The traffic descriptor includes at least one of the following: a destination IP triplet, a fully qualified domain name FQDN, or a uniform resource locator URL; and the route selection descriptor includes at least one of the following: a session and service continuity mode, a data network name, a connection capability, single network slice selection assistance information, a PDU session type, or an access type preference.

For example, the policy control network element may request the session management network element to release a PDU session that carries the application traffic of the first application, and then create a PDU session to carry the application traffic of the first application. The created PDU session is created based on an RSD in the first URSP rule. For example, the policy control network element requests the session management network element to create a PDU session to carry the application traffic of the first application by using an SSC mode 3, and then releases the established PDU session that carries the application traffic of the first application. This consideration is that when the terminal cannot carry application traffic according to the first URSP rule, the network side releases a PDU session whose PDU session parameter or attribute does not meet an RSD in a URSP rule. In addition, the network side strictly establishes, according to a parameter of the RSD in the first URSP rule, the PDU session to carry the application traffic.

For example, for a first application (for example, an APP 1), the first URSP rule is: a traffic descriptor is equal to an IP triplet 10.1.1.1, an RSD includes: an S-NSSAI is equal to an S-NSSAI-a, and an access mode is a URSP rule of WLAN. It is assumed that the terminal uses the first URSP rule for application traffic of the App 1, and does not match the application traffic of the App 1 to a correct PDU session. In this case, the policy control network element sends a first request to the session management network element to request to release an old PDU session that carries the application traffic, and sends, to the session management network element by using the first request, a parameter such as a traffic descriptor or a route selection descriptor in the first URSP rule. In a case that the first request is received, the session management network element establishes, according to the foregoing parameter, a new PDU session used to carry the application traffic of the App 1. A session parameter of the new PDU session is: an S-NSSAI is equal to an S-NSSAI-a, and an access mode is: a URSP rule of WLAN. These parameters are consistent with a parameter in an RSD if the first URSP rule is: a traffic descriptor is equal to an IP triplet 10.1.1.1.

In this embodiment of this application, in a case that it is determined that the terminal does not execute the first URSP rule, the URSP rule monitoring and reporting method provided in this embodiment of this application further includes the following step 303a2.

Step 303a2: The policy control network element sends a second URSP rule to the terminal.

The second URSP rule includes a session attribute or a session parameter of a second PDU session that carries the application traffic of the terminal and a third traffic descriptor. The session attribute or the session parameter of the second PDU session is used to form an RSD in a new URSP rule delivered to the terminal.

The third traffic descriptor matches the related information of the first application, and a route selection descriptor corresponding to the third traffic descriptor matches the session attribute of the second PDU session that carries the application traffic.

For example, the policy control network element may send a terminal policy to the terminal by using a downlink NAS message, where the terminal policy includes the second URSP rule.

For example, the policy control network element may instruct the terminal to re-match the application traffic of the first application by using the second URSP rule, to re-determine a PDU session that carries the application traffic. In a case that the second URSP rule is received, the terminal may re-match the application traffic of the first application based on the second URSP rule, to match the application traffic to a correct PDU session; or the terminal may use the second URSP rule to match subsequent application traffic of the first application.

In this embodiment of this application, before step 301, the URSP rule monitoring and reporting method provided in this embodiment of this application further includes the following step D1.

Step D1: The policy control network element sends a first policy to the terminal.

The first policy includes at least one of the following:
a URSP rule that needs to be monitored by the terminal;
a URSP rule corresponding to a first rule precedence that needs to be monitored by the terminal;
a first traffic descriptor that needs to be monitored by the terminal; or
a first route selection descriptor that needs to be monitored by the terminal.

For example, the policy control network element may send a terminal policy (UE policy) to the terminal by using a downlink NAS message, where the terminal policy includes a terminal policy container, and the terminal policy container includes the first policy.

For example, the NAS message may be Namf_Communication_NIN2MessageTransfer signaling.

For example, the policy control network element may indicate, to the terminal by using the first policy, a URSP rule whose evaluation result needs to be monitored, and in a case that the first policy is received, the terminal may monitor a URSP rule in the terminal according to the indication of the first policy.

In some embodiments, the PCF may obtain policy data information from a unified data storage network element UDR, and generate the first policy according to the policy data information.

For example, the policy data information includes at least one of the following:
a terminal user permanent identifier;
policy data;
a terminal context policy control data; or
a policy set entry.

Further, in this embodiment of this application, before the foregoing step D1, the URSP rule monitoring and reporting method provided in this embodiment of this application may include the following step E1.

Step E1: The policy control network element receives a first policy control creation request.

The first policy creation request includes terminal capability information, and the terminal capability information is used to indicate that the terminal has a capability of monitoring evaluation result of a URSP rule.

Further, in this embodiment of this application, after the foregoing step D1, the URSP rule monitoring and reporting method provided in this embodiment of this application may include the following step D2.

Step D2: The policy control network element sends a subscription message to a session management network element.

The subscription message is used by the policy control network element to subscribe to evaluation result of the first URSP rule by the terminal; and the subscription message includes at least one of the following: a terminal user permanent identifier, or a traffic descriptor in the first URSP rule.

Further, the traffic descriptor may include at least one of the following: a destination Internet Protocol IP triplet, a fully qualified domain name FQDN, a uniform resource locator URL, an application descriptor, a connection capability, or a DNN.

For example, the terminal user permanent identifier in the subscription message and the traffic descriptor in the first URSP rule are used by the session management network element to generate a packet detection rule PDR.

Further, packet detection information of the packet detection rule includes at least one of the following: a DNN, an APP descriptor, a connection capability, a destination Internet Protocol IP triplet, a fully qualified domain name FQDN, or a uniform resource locator URL.

An embodiment of this application provides a URSP rule monitoring and reporting method. As shown in FIG. 4, the method includes the following step 401.

Step 401: A session management network element sends second information to a policy control network element.

The second information includes first attribute information of a target packet data unit PDU session that carries application traffic of a terminal, and the first attribute information is used by the policy control network element to determine whether the terminal executes a first URSP rule.

In this embodiment of this application, the first attribute information includes at least one of the following: a session and service continuity mode, a data network name, a connection capability, single network slice selection assistance information, a PDU session type, an access type preference, a PDU session ID, a destination Internet Protocol IP triplet, a fully qualified domain name FQDN, or a uniform resource locator URL.

In this embodiment of this application, before the foregoing step 401, the URSP rule monitoring and reporting method provided in this embodiment of this application further includes the following step F1 and step F2.

Step F1: The session management network element receives a target session identifier sent by a user plane management function network element.

Step F2: The session management network element determines, according to the target session identifier, the target PDU session that carries the application traffic of the terminal and the first attribute information of the target PDU session.

In some embodiments, the target session identifier is a target session identifier corresponding to a target data packet that is of the target PDU session carrying the application traffic of the terminal and that is detected by the user plane management network element from a plurality of data packets according to a packet detection rule sent by the session management network element.

For example, a plurality of PDU session anchor network elements PSAs or UPFs in the user plane management network element receive a plurality of data packets from an application, and the user plane management network element may detect the target data packet of the target PDU session from the PDR sent by the session management network element, and send the target session identifier corresponding to the target data packet to the session management network element SMF.

It should be understood that the target session identifier is a target session identifier of the target PDU session.

Further, in this embodiment of this application, before the foregoing step F1, the URSP rule monitoring and reporting method provided in this embodiment of this application further includes the following step G1.

Step G1: The session management network element sends a packet detection rule PDR to the user plane management function network element.

The packet detection rule includes at least one of the following: a data network name, an application descriptor, a connection capability, a destination Internet Protocol IP triplet, a fully qualified domain name FQDN, or a uniform resource locator URL.

In this embodiment of this application, before the foregoing step 401, the URSP rule monitoring and reporting method provided in this embodiment of this application further includes the following step H1 and step H2.

Step H1: The session management network element receives a first subscription message sent by the policy control network element.

Step H2: The session management network element generates a packet detection rule according to the first subscription message.

The first subscription message includes at least one of the following: a terminal user permanent identifier, or a traffic descriptor, where the traffic descriptor includes at least one of the following: a destination IP triplet, an FQDN, or a URL.

According to step H1, the session management network element may receive first request information sent by the policy control network element, where the first request information is used by the SMF to generate the packet detection rule.

For example, the session management network element may generate the PDR according to information in the first subscription message (for example, a terminal user permanent identifier, a destination IP triplet, an FQDN, and a URL).

In this embodiment of this application, after the foregoing step 401, the URSP rule monitoring and reporting method provided in this embodiment of this application further includes the following step I1 and step I2.

Step I1: The session management network element receives a first request sent by the policy control network element.

Step I2: The session management network element releases a PDU session that carries application traffic, and establishes a new PDU session to carry the application traffic.

In some embodiments, the first request carries at least one of the following:
a terminal user permanent identifier;
a PDU session ID of a PDU session that carries application traffic; or
a traffic descriptor or a route selection descriptor in the first URSP rule, where
the traffic descriptor includes at least one of the following: a destination IP triplet, a fully qualified domain name FQDN, or a uniform resource locator URL; and the route selection descriptor includes at least one of the following: a session and service continuity mode, a data network name, a connection capability, single network slice selection assistance information, a PDU session type, or an access type preference.

For example, the session management network element may release, according to the PDU session ID of the PDU session that carries the application traffic, an established PDU session that carries the application traffic of the first application.

For example, the session management network element may establish a new PDU session according to the destination IP triplet, the URL, the SSC mode, or the like in the traffic descriptor to carry the application traffic of the first application.

For example, the session management network element determines, from the user plane management network element according to a unified data storage network element, that a session attribute of a PDU session whose PDU session ID is equal to 1 and that carries application data is inconsistent with an RSD of URSP rules, and the policy control network element sends a request to request the session management network element to release the PDU session whose PDU session ID is equal to 1, and provides a parameter (for example, an IP triple 10.1.1.1, S-NSSAI=S-NSSAI-a, or an access mode WLAN) for the session management network element. After receiving the request, the SMF establishes a new PDU session to carry the application traffic.

An embodiment of this application provides a URSP rule monitoring and reporting method. As shown in FIG. 5, the method includes the following step 501.

Step 501: A user plane management function network element sends a target session identifier of a target packet data unit PDU session to a session management network element.

The target PDU session is used to carry a first data packet of a first application, the first data packet is a data packet detected by the user plane management function network element by using a packet detection rule, the target session identifier is used by the session management network element to determine a target PDU session that carries application traffic of a terminal and first attribute information of the target PDU session, and the first attribute information is used by a policy control network element to determine whether the terminal executes a first URSP rule.

In this embodiment of this application, before step 501, the URSP rule monitoring and reporting method provided in this embodiment of this application further includes the following step 502.

Step 502: The user plane management function network element determines, according to the packet detection rule in a case that a data packet of application traffic is received, the first data packet of the first application after the terminal executes the first URSP rule.

In some embodiments, with reference to the foregoing step 502, the foregoing step 501 may include the following step 501a.

Step 501a: The user plane management function network element sends a target session identifier of the first data packet of the first application to the session management network element.

In some embodiments, the packet detection rule includes at least one of the following: a data network name, an application descriptor of an application, a connection capability, a destination Internet Protocol IP triplet, a fully qualified domain name FQDN, or a uniform resource locator URL.

Further, in this embodiment of this application, the foregoing step 502 may include the following step 502a and step 502b.

Step 502a: The user plane management function network element determines attribute information of the data packet according to the packet detection rule in a case that the data packet of the application traffic is received.

Step 502b: The user plane management network element determines the first data packet of the first application in the data packet according to the attribute information of the data packet.

In some embodiments, the attribute information of the data packet includes at least one of the following:
a data network name to which the data packet is to be sent;
application description information of the data packet; or
a packet connection capability of the data packet, where
the packet connection capability includes at least one of the following: an IP multimedia subsystem IMS, a multimedia information service MMS, or the Internet.

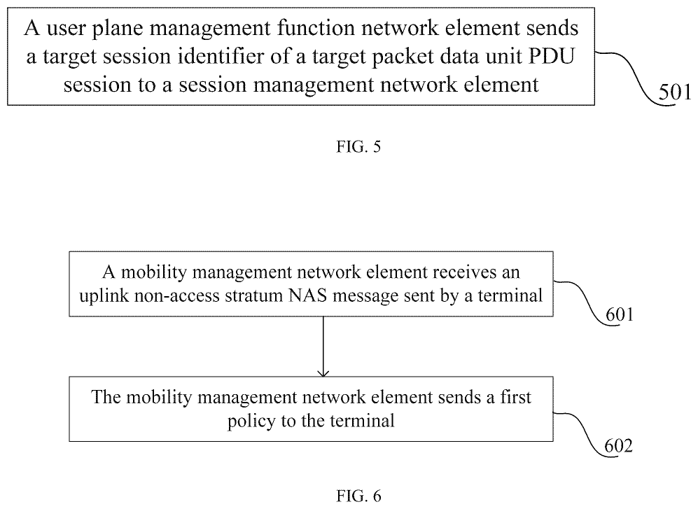

An embodiment of this application provides a URSP rule monitoring and reporting method. As shown in FIG. 6, the method includes the following steps 601 and 602.

Step 601: A mobility management network element receives an uplink non-access stratum NAS message sent by a terminal.

Step 602: The mobility management network element sends a first policy to the terminal.

The uplink NAS message carries a registration request, the registration request includes terminal capability information, and the terminal capability information is used to indicate that the terminal has a capability of monitoring evaluation result of a URSP rule.

In some embodiments, the first policy is used to indicate at least one of the following:
a URSP rule that needs to be monitored by the terminal;
a URSP rule corresponding to a first rule precedence that needs to be monitored by the terminal;
a first traffic descriptor that needs to be monitored by the terminal; or
a first route selection descriptor that needs to be monitored by the terminal.

The following uses several examples to describe the technical solutions provided in the embodiments of this application.

The following is described by using an example in which a terminal is UE, a policy control network element is a PCF, a session management network element is an SMF, a user plane management function network element is a UPF, a mobility management network element is an AMF, a PDU session anchor network element is a PSA, a unified data storage network element is a UDR, and a unified data management function network element is a UDM. It should be noted that the network element name in the following example is merely an example. In actual application, another network element name may be used. This is not limited in the embodiments of this application.

### Embodiment 1

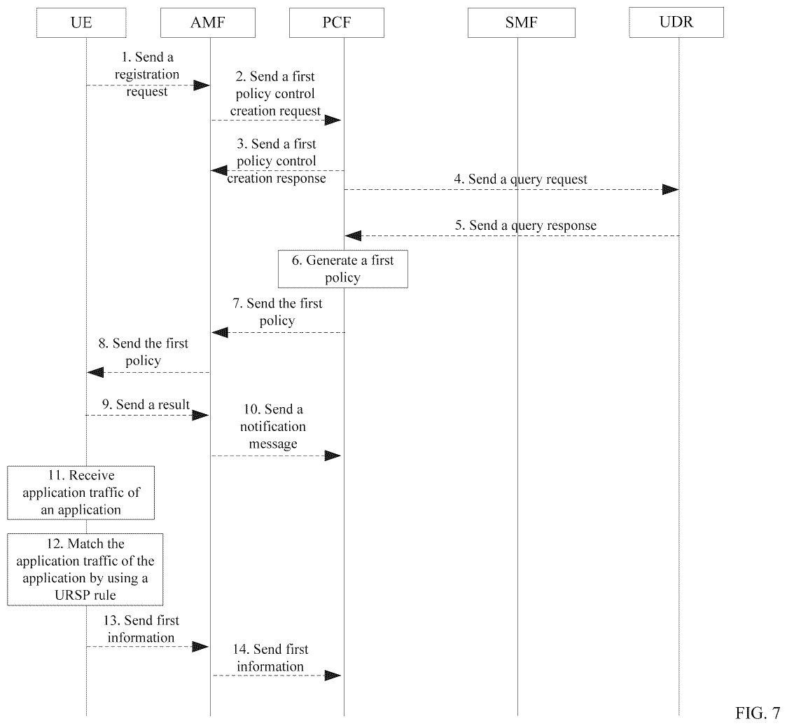

For example, as shown in FIG. 7, the technical solution provided in this embodiment may be implemented by using the following steps.

Step 1: UE sends a registration request to an AMF.

For example, the registration request is used to request to deliver a first policy.

For example, the registration request includes terminal capability information.

Step 2: The AMF receives the registration request sent by the UE, and the AMF sends a first policy control creation request to a PCF.

For example, the first policy control creation request is used to request to establish a terminal policy association.

The first policy creation request includes terminal capability information, and the terminal capability information is used to indicate that the UE has a capability of monitoring evaluation result of a URSP rule.

For example, the first policy creation request may be Npcf_UEPolicyControl Create Request.

Step 3: The PCF receives the first policy control creation request sent by the AMF, and sends a first policy control creation response to the AMF.

For example, the first policy control creation response includes a policy control trigger parameter.

For example, the PCF may send the first policy control creation response to the AMF by using Npcf_UEPolicyControl Create Response signaling.

For example, the PCF may also subscribe to N1 message delivery and subscribe to a specific N1 message type to determine whether the first policy sent by using the N1 message is successfully sent.

Step 4: The PCF sends a query request to a UDR.

For example, the query request is used to request to obtain policy data information in a unified data storage network element.

For example, the query request may be Nudr_DM_Query.

Step 5: The UDR sends a query response to the PCF.

For example, the query response may be Nudr_DM_Query Response.

Step 6: The PCF generates the first policy according to the policy data information obtained from the UDR.

For example, if the PCF receives the capability of monitoring a URSP rule by the terminal from the UE, the first policy may include a URSP rule that needs to be monitored by the terminal on the network side.

Step 7: The PCF sends the first policy to the AMF.

For example, the first policy may be sent to the UE (sent to the UE through the AMF) by using the following signaling: Namf_Communication_NIN2MessageTransfer, including a UE policy container. The UE policy container includes a terminal policy or a URSP rule that needs to be monitored by the terminal on the network side.

Step 8: The AMF transparently transmits the first policy to the UE.

For example, when the UE is in a connected state (CM-CONNECTED), the AMF transparently transmits the first policy to the UE. The AMF does not perform any processing on the first policy. The AMF sends the first policy by using a downlink NAS message.

Step 9: The UE sends a result to the AMF.

For example, the UE may save the first policy, and then send the result to the AMF.

For example, the UE may send the result to the AMF by using an uplink NAS message (UL NAS message), to indicate that the first policy is successfully received.

Step 10: The AMF sends a notification message to the PCF.

For example, the notification message is used to notify the PCF when the PCF subscribes to the first policy sent to the UE, and the UE successfully receives the first policy.

For example, the notification message may be Namf_Communication_N1MessageNotify.

Step 11: The UE receives application traffic of an application. In this case, traffic of the application on the terminal needs to be sent, where the application traffic has a traffic characteristic.

Step 12: The UE matches the application traffic of the application by using the URSP rule, and monitors and reports an execution and matching status according to the first policy. In this case, the application traffic of the application is matched to a PDU session on the terminal.

Step 13: The UE sends first information to the AMF by using an uplink NAS message.

For example, the first information is used to indicate evaluation result of a first URSP rule by the UE.

For example, the uplink NAS message may be UL NAS Transport.

Step 14: The AMF sends the first information to the PCF by using an N1 message (for example, Namf_Communication_N1MessageNotify). The PCF learns about the URSP rule enforcement in the terminal, and the network side may subsequently optimize the UE policy, or learns about the URSP rule enforcement in the terminal.

### Embodiment 2

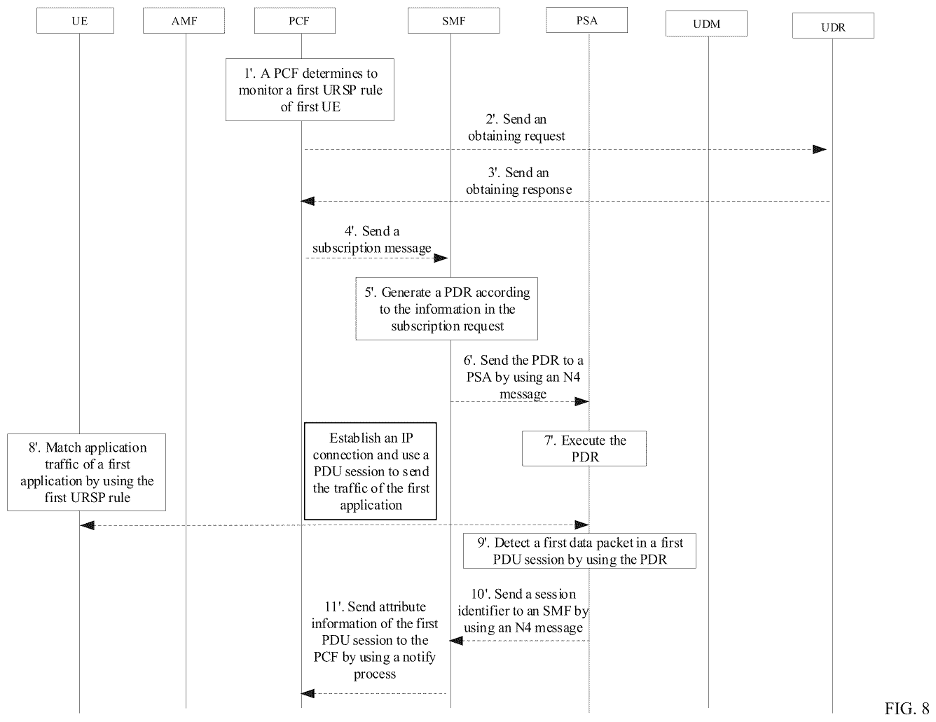

For example, as shown in FIG. 8, the technical solution provided in this embodiment may be implemented by using the following steps.

Step 1′: A PCF determines to monitor a first URSP rule of first UE.

Step 2′: The PCF sends an obtaining request to a UDM to obtain an ID of an SMF that serves the UE.

For example, the obtaining request may be Nudm_UECM_Get.

Step 3′: The UDM receives the obtaining request sent by the PCF, and sends an obtaining response to the PCF.

For example, the obtaining response includes ID information of the SMF.

It should be noted that, step 2′ and step 3′ are performed to monitor evaluation result of a URSP rule in UE by the PCF. Therefore, a PDU session of the UE needs to be monitored to detect whether a packet of an application exists in the PDU session. However, the PCF needs to know the SMF that manages the current UE PDU session.

Step 4′: The PCF subscribes to an execution result of the first URSP rule, or the PCF sends an obtaining request of an execution result of the first URSP rule. The PCF sends a subscription message or an execution result obtaining request to the SMF.

For example, the subscription message (that is, a subscription request) or the obtaining request includes at least one of the following: a terminal user permanent identifier, or a traffic descriptor in the first URSP rule.

For example, the traffic descriptor includes at least one of the following: a destination Internet Protocol IP triplet, a fully qualified domain name FQDN, or a uniform resource locator URL.

Step 5′: The SMF receives the subscription message or the obtaining request sent by the PCF, and generates a PDR according to the foregoing information in the subscription request or the obtaining request (for example, the destination IP triplet, the FQDN, and the URL in the traffic descriptor).

Step 6′: The SMF sends the PDR to a PSA by using an N4 message, where the PDR is used to detect a data packet of a target application on a terminal.

For example, if the UE has a plurality of PDU sessions or a plurality of anchors, a plurality of PDRs are sent to a plurality of PSAs.

Step 7′: The PSA executes the PDR to detect the data packet or data flow of the target application.

Step 8′: The UE matches application traffic of a first application by using the first URSP rule, and matches the application traffic of the first application to a first PDU session.

Step 9′: The PSA detects, by using the PDR, a first data packet in the first PDU session that belongs to the terminal.

Step 10′: The PSA sends a session identifier PDU session ID to the SMF by using an N4 message.

For example, the session identifier is used by the SMF to determine the first PDU session corresponding to the first data packet.

For example, the session identifier may be an N4 session ID.

For example, after determining the first PDU session in the first data packet, the SMF may determine attributes of the first PDU session of the UE: an SSC mode, a DNN, a connection capability, an S-NSSAI, and the like.

Step 11′: The SMF sends the attribute information of the first PDU session to the PCF by using a notify process. That is, after the UPF detects a data packet of an application by using the PDR (the PDR generated according to the information sent by the PCF) sent by the PCF/SMF, it is determined that the data packet of the application has been sent in a PDU session of the terminal, and the UPF or the SMF needs to send a session attribute or a session parameter of a PDU session in which the traffic or data packet of the application is located to the PCF. The PCF compares the session parameter or attribute of the PDU session with an RSD in a URSP rule.

For example, after receiving the PDU session attribute or the parameter information sent by the SMF, the PCF determines, according to the session attribute (that is, the attribute information) of the first PDU session, an RSD that matches the PDU session (for example, a DNN and an SSC mode that match the PDU session), and then determines URSP rules (for example, a traffic descriptor and an RSD) used by the UE for application traffic carried in the first PDU session.

### Embodiment 3

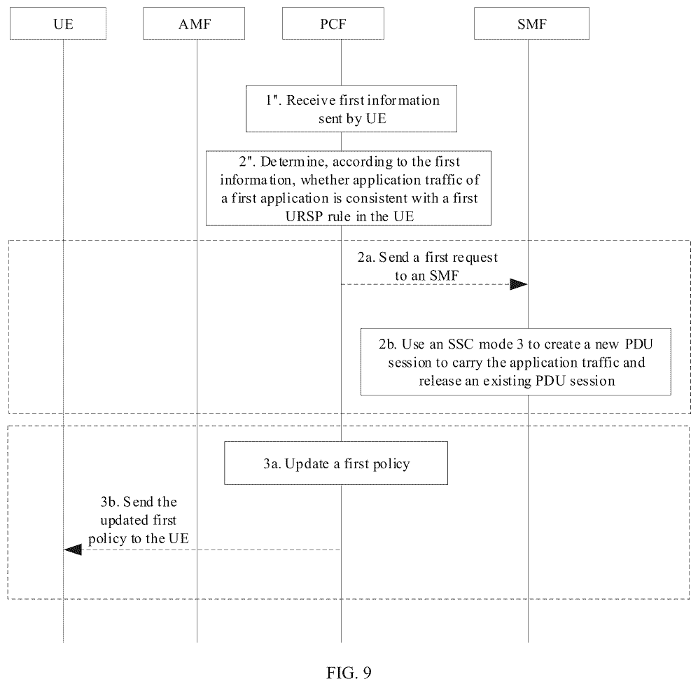

For example, as shown in FIG. 9, the technical solution provided in this embodiment may be implemented by using the following steps.

Step 1″: A PCF receives first information sent by UE, where the first information includes a monitoring result of a use or evaluation result of a URSP rule by the terminal.

Step 2″: The PCF determines, according to the first information, whether application traffic of a first application is consistent with a first URSP rule in the UE. If yes, the PCF records a PDU session that matches the application traffic, and if no, performs the following step 2a and step 2b.

Step 2a: The PCF sends a first request to an SMF.

For example, the first request is used to request at least one of the following:
releasing a PDU session that carries application traffic; or
establishing a new PDU session to carry the application traffic, where a session parameter or attribute of the new PDU session is consistent with a PDU session parameter or attribute in an RSD in the first URSP rule.

Step 2b: The SMF uses an SSC mode 3 to create the new PDU session to carry the foregoing application traffic and release the existing PDU session. The session parameter or attribute of the new PDU session is consistent with the PDU session parameter or attribute in the RSD in the first URSP rule.

In some embodiments, the foregoing step 2a and step 2b may be replaced with the following step 3a and step 3b.

Step 3a: The PCF updates a first policy.

Step 3b: The PCF sends the updated first policy to the UE.

For example, the updated first policy includes a second URSP rule, and the second URSP rule includes a session attribute of a second PDU session that carries application traffic of the terminal and a third traffic descriptor. That is, when a network detects that the PDU session parameter or attribute that carries the current application traffic is different from the PDU session parameter or attribute in the RSD in the first URSP rule, the PCF updates the RSD in the first URSP rule, and a parameter in the RSD is the PDU session parameter or attribute that currently carries the application data flow of the first application.

The third traffic descriptor matches related information of the first application; and a route selection descriptor in the third traffic descriptor matches the session attribute of the second PDU session that carries the foregoing application traffic.

The URSP rule monitoring and reporting method provided in the embodiments of this application may be performed by a URSP rule monitoring and reporting apparatus. In the embodiments of this application, an example in which the URSP rule monitoring and reporting apparatus performs the URSP rule monitoring and reporting method is used to describe the URSP rule monitoring and reporting apparatus provided in the embodiments of this application.

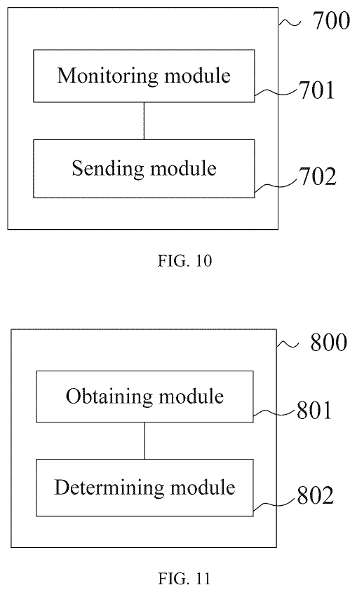

An embodiment of this application provides an URSP rule monitoring and reporting apparatus 700. As shown in FIG. 10, the apparatus 700 includes a monitoring module 701 and a sending module 702. The monitoring module 701 is configured to monitor evaluation result of a first URSP rule; and the sending module 702 is configured to send first information according to the evaluation result monitored by the monitoring module, where the first URSP rule includes at least one URSP rule in URSP rules in the terminal, and one URSP rule corresponds to one rule precedence; and the first information is used to indicate at least one of the following: whether the first URSP rule is evaluated by the terminal, related information of a first application, or a first packet data unit PDU session that application traffic of the first application matches, where the first application is an application for which the first URSP rule in the terminal is used when the first URSP rule is evaluated by the terminal.

In this embodiment of this application, the related information includes at least one of the following: a traffic characteristic of the first application, where the traffic characteristic includes at least one of the following: a traffic descriptor of the application traffic, a destination IP triplet of the application traffic, a fully qualified domain name FQDN of the application traffic, a data network name DNN of the application traffic, or a connection capability of the application traffic.

In this embodiment of this application, the first URSP rule includes at least one of the following: a URSP rule corresponding to a first rule precedence in a plurality of URSP rules in the terminal; a first traffic descriptor in the first rule precedence; or a first route selection descriptor in the first rule precedence, where the first rule precedence includes at least one rule precedence, and the first route selection descriptor includes at least one route selection descriptor in the first traffic descriptor.

In this embodiment of this application, the apparatus further includes an execution module, where the execution module is configured to: in a case that the application traffic of the first application in the terminal needs to be sent, match the application traffic according to the first URSP rule; and the execution module is further configured to: match the application traffic to the first PDU session, or establish a second PDU session that matches the application traffic; and the sending module is configured to: after the execution module matches the application traffic to the first PDU session or establishes the second PDU session that matches the application traffic, send the first information according to the evaluation result.

In this embodiment of this application, the first information includes at least one of the following: traffic description information of the application traffic; a URSP rule evaluated by the terminal; a traffic descriptor selected by the terminal; a route selection descriptor selected by the terminal; a precedence of the traffic descriptor selected by the terminal; a precedence of the route selection descriptor selected by the terminal; a rule precedence selected by the terminal; or a PDU session or a PDU session attribute that carries the application traffic, where the session attribute of the PDU session includes at least one of the following: a session and service continuity mode, a data network name, a connection capability, single network slice selection assistance information, a PDU session type, an access type preference, or a PDU session identity ID.

In this embodiment of this application, the apparatus further includes a receiving module, where the receiving module is configured to receive a first policy sent by a first network element, where the first network element includes a mobility management network element or a policy control network element; and the monitoring module is configured to: determine the first URSP rule according to the first policy received by the receiving module, and monitor the evaluation result of the first URSP rule.

In this embodiment of this application, the first policy is used to indicate at least one of the following:
a URSP rule that needs to be monitored by the terminal;
a URSP rule corresponding to a first rule precedence that needs to be monitored by the terminal;
a first traffic descriptor that needs to be monitored by the terminal; or
a first route selection descriptor that needs to be monitored by the terminal.

In this embodiment of this application, the first traffic descriptor is a traffic descriptor in the first rule precedence; and the first route selection descriptor is a route selection descriptor in the first rule precedence, and the first rule precedence includes at least one rule precedence.

In this embodiment of this application, the apparatus further includes a sending module, where the sending module is configured to send a registration request to a mobility management network element by using an uplink non-access stratum NAS message, where the registration request is used to request to deliver a first policy.

In this embodiment of this application, the registration request includes terminal capability information, and the terminal capability information is used to indicate that the terminal has a capability of monitoring evaluation result of a URSP rule.

In this embodiment of this application, the sending module is configured to send the first information to a first network element according to the evaluation result, where the first network element includes a mobility management network element or a policy control network element.

An embodiment of this application provides a URSP rule monitoring and reporting apparatus 800. As shown in FIG. 11, the apparatus 800 includes an obtaining module 801 and a determining module 802. The obtaining module 801 is configured to obtain target information; and the determining module 802 is configured to determine, according to the target information obtained by the obtaining module, whether a terminal executes a first URSP rule, where the first URSP rule includes at least one URSP rule in URSP rules in the terminal, and one URSP rule corresponds to one rule precedence.

In this embodiment of this application, the target information includes at least one of the following: first information sent by the terminal, or second information sent by a session management network element, where the first information is used to indicate at least one of the following: whether the first URSP rule is evaluated by the terminal, related information of a first application, or a target packet data unit PDU session that application traffic of the first application matches, where the first application is an application for which the first URSP rule in the terminal is used when the first URSP rule is evaluated by the terminal and the second information includes first attribute information of a target packet data unit PDU session that carries application traffic of the terminal.

In this embodiment of this application, the related information includes a traffic characteristic of the first application, where

the traffic characteristic includes at least one of the following: a traffic descriptor of the application traffic, a destination IP triplet of the application traffic, a fully qualified domain name FQDN of the application traffic, a data network name DNN of the application traffic, or a connection capability of the application traffic.

In this embodiment of this application, the first information includes at least one of the following:
traffic description information of application traffic of the terminal;
a URSP rule evaluated by the terminal;
a traffic descriptor selected by the terminal;
a selected route selection descriptor;
a precedence of the traffic descriptor selected by the terminal;
a precedence of the route selection descriptor selected by the terminal;
a rule precedence selected by the terminal; or
a PDU session or a PDU session attribute that carries the application traffic of the terminal, where the session attribute of the PDU session includes at least one of the following: a session and service continuity mode, a data network name, a connection capability, single network slice selection assistance information, a PDU session type, an access type preference, or a PDU session identity ID.

In this embodiment of this application, the first attribute information includes at least one of the following: a session and service continuity mode, a data network name, a connection capability, single network slice selection assistance information, a PDU session type, an access type preference, a PDU session ID, a destination Internet Protocol IP triplet, a fully qualified domain name FQDN, or a uniform resource locator URL.

In this embodiment of this application, the determining module is configured to:
in a case that the target information meets a first condition, determining, by the determining module, that the terminal executes the first URSP rule; and
in a case that the target information meets a second condition, determining, by the determining module, that the terminal does not execute the first URSP rule.

In this embodiment of this application, that the target information meets a first condition includes at least one of the following:
the related information that is of the first application and that is indicated by the first information matches a second traffic descriptor in the first URSP rule, and the first attribute information of the target PDU session that carries the application traffic matches at least one route selection descriptor in the second traffic descriptor; or
the first attribute information of the target PDU session that carries the application traffic in the second information matches at least one route selection descriptor in at least one traffic descriptor in the first URSP rule, where
the second traffic descriptor is any traffic descriptor in the first URSP rule.

In this embodiment of this application, in a case that the target information meets the first condition, the first URSP rule evaluated by the terminal includes at least one of the following:
any route selection descriptor in the second traffic descriptor, where the second traffic descriptor matches the related information of the first application, and the any route selection descriptor matches the first attribute information of the target PDU session;
a traffic descriptor including the at least one route selection descriptor; or
a URSP rule including the at least one route selection descriptor.

In this embodiment of this application, that the target information meets a second condition includes at least one of the following:
the related information that is of the first application and that is indicated by the first application does not match a second traffic descriptor in the first URSP rule, or the related information that is of the first application and that is indicated by the first application matches a second traffic descriptor in the first URSP rule, and the first attribute information of the target PDU session that carries the application traffic does not match all route selection descriptors in the second traffic descriptor; or
the first attribute information of the target PDU session that carries the application traffic in the second information does not match any route selection descriptor in any traffic descriptor in the first URSP rule.

In this embodiment of this application, in a case that it is determined that the terminal does not execute the first URSP rule, the apparatus further includes a sending module, where
the sending module is configured to send a first request to a session management network element, where the first request is used to request at least one of the following:
releasing a PDU session that carries application traffic, or establishing a new PDU session to carry the application traffic, where
a session attribute of the new PDU session is consistent with a PDU session attribute included in a route selection descriptor in a second traffic descriptor in the first URSP rule, where the second traffic descriptor is any traffic descriptor in the first URSP rule, and the second traffic descriptor matches the related information of the first application.

In this embodiment of this application, the first request carries at least one of the following:
a terminal user permanent identifier;
a PDU session ID of a PDU session that carries application traffic; or
a traffic descriptor or a route selection descriptor in the first URSP rule, where
the traffic descriptor includes at least one of the following: a destination IP triplet, a fully qualified domain name FQDN, or a uniform resource locator URL; and the route selection descriptor includes at least one of the following: a session and service continuity mode, a data network name, a connection capability, single network slice selection assistance information, a PDU session type, or an access type preference.

In this embodiment of this application, in a case that it is determined that the terminal does not execute the first URSP rule, the apparatus further includes a sending module, where
the sending module is configured to send a second URSP rule to the terminal, where the second URSP rule includes a session attribute of a second PDU session that carries the application traffic of the terminal and a third traffic descriptor, where
the third traffic descriptor matches the related information of the first application, and a route selection descriptor in the third traffic descriptor matches the session attribute of the second PDU session that carries the application traffic.

In this embodiment of this application, the apparatus further includes a sending module, where the sending module is configured to send a first policy to the terminal, where the first policy includes at least one of the following:
a URSP rule that needs to be monitored by the terminal;
a URSP rule corresponding to a first rule precedence that needs to be monitored by the terminal;
a first traffic descriptor that needs to be monitored by the terminal; or
a first route selection descriptor that needs to be monitored by the terminal.

In this embodiment of this application, the apparatus further includes a receiving module, where the receiving module is configured to receive a first policy control creation request, where the first policy creation request includes terminal capability information, and the terminal capability information is used to indicate that the terminal has a capability of monitoring evaluation result of a URSP rule.

In this embodiment of this application, the sending module is further configured to send a subscription message to a session management network element, where
the subscription message is used to subscribe to evaluation result of the first URSP rule by the terminal, and the subscription message includes at least one of the following: a terminal user permanent identifier, or a traffic descriptor in the first URSP rule, where
the traffic descriptor includes at least one of the following: a destination Internet Protocol IP triplet, a fully qualified domain name FQDN, or a uniform resource locator URL.

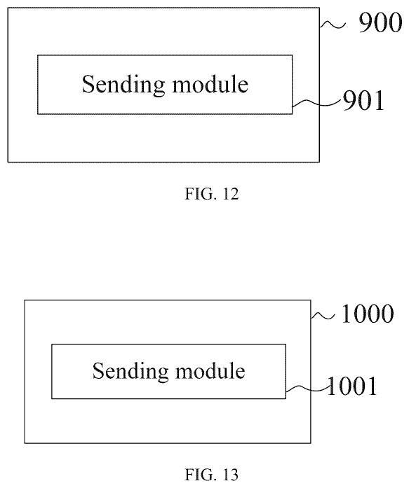

An embodiment of this application provides a URSP rule monitoring and reporting apparatus 900. As shown in FIG. 12, the apparatus 900 includes a sending module 901, where the sending module 901 is configured to send second information to a policy control network element, where the second information includes first attribute information of a target packet data unit PDU session that carries application traffic of a terminal, and the first attribute information is used by the policy control network element to determine whether the terminal executes a first URSP rule.

In this embodiment of this application, the first attribute information includes at least one of the following: a session and service continuity mode, a data network name, a connection capability, single network slice selection assistance information, a PDU session type, an access type preference, a PDU session ID, a destination Internet Protocol IP triplet, a fully qualified domain name FQDN, or a uniform resource locator URL.

In this embodiment of this application, the apparatus further includes a receiving module and a determining module, where
the receiving module is configured to receive a target session identifier sent by a user plane management function network element; and
the determining module is configured to determine, according to the target session identifier received by the receiving module, the target PDU session that carries the application traffic of the terminal and the first attribute information of the target PDU session.

In this embodiment of this application, the sending module is further configured to send a packet detection rule PDR to the user plane management function network element, where the packet detection rule includes at least one of the following: a data network name, an application descriptor, a connection capability, a destination Internet Protocol IP triplet, a fully qualified domain name FQDN, and a uniform resource locator URL.

In this embodiment of this application, the apparatus further includes a receiving module and a generation module. The receiving module is configured to receive a first subscription message sent by the policy control network element; and the generation module is configured to generate a packet detection rule according to the first subscription message received by the receiving module, where the first subscription message includes at least one of the following: a terminal user permanent identifier, and a traffic descriptor, where the traffic descriptor includes at least one of the following: a destination IP triplet, an FQDN, and a URL.

An embodiment of this application provides a URSP rule monitoring and reporting apparatus 1000. As shown in FIG. 13, the apparatus 1000 includes a sending module 1001, where the sending module 1001 is configured to send a target session identifier of a target packet data unit PDU session to a session management network element, where the target PDU session is used to carry a first data packet of a first application, the first data packet is a data packet detected by a user plane management function network element by using a packet detection rule, the target session identifier is used by the session management network element to determine a target PDU session that carries application traffic of a terminal and first attribute information of the target PDU session, and the first attribute information is used by a policy control network element to determine whether the terminal executes a first URSP rule.

In this embodiment of this application, the apparatus further includes a determining module, where the determining module is configured to determine, according to the packet detection rule in a case that a data packet of application traffic is received, the first data packet of the first application after the terminal executes the first URSP rule; and

the sending module is configured to send, to the session management network element, the target session identifier of the first data packet that is of the first application and that is determined by the determining module.

In this embodiment of this application, the packet detection rule includes at least one of the following: a data network name, an application descriptor of an application, a connection capability, a destination Internet Protocol IP triplet, a fully qualified domain name FQDN, and a uniform resource locator URL.

In this embodiment of this application, the determining module is configured to: in a case that a data packet of application traffic is received, determine attribute information of the data packet according to the packet detection rule; and the determining module is configured to determine the first data packet of the first application in the data packet according to the attribute information of the data packet.

In this embodiment of this application, the attribute information of the data packet includes at least one of the following:
a data network name to which the data packet is to be sent;
application description information of the data packet; and
a packet connection capability of the data packet, where
the packet connection capability includes at least one of the following: an IMS, an MMS, and the Internet.

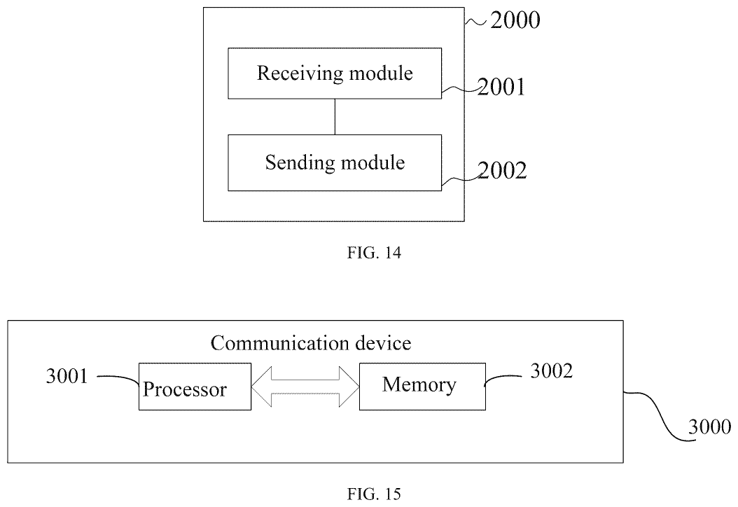

An embodiment of this application provides a URSP rule monitoring and reporting apparatus 2000. As shown in FIG. 14, the apparatus 2000 includes a receiving module 2001 and a sending module 2002. The receiving module 2001 is configured to receive an uplink non-access stratum NAS message sent by a terminal; and the sending module 2002 is configured to send, to the terminal, a first policy received by the receiving module 2001, where

the uplink NAS message carries a registration request; and the registration request includes terminal capability information, and the terminal capability information is used to indicate that the terminal has a capability of monitoring evaluation result of a URSP rule.

In this embodiment of this application, the first policy is used to indicate at least one of the following:
a URSP rule that needs to be monitored by the terminal;
a URSP rule corresponding to a first rule precedence that needs to be monitored by the terminal;
a first traffic descriptor that needs to be monitored by the terminal; and
a first route selection descriptor that needs to be monitored by the terminal.

The URSP rule monitoring and reporting apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11. The another device may be a server, a Network Attached Storage (NAS), or the like. This is not limited in this embodiment of this application.

The URSP rule monitoring and reporting apparatus provided in this embodiment of this application can implement the processes implemented in the method embodiments in FIG. 1 to FIG. 9, and achieve a same technical effect. To avoid repetition, details are not described herein again.

As shown in FIG. 15, an embodiment of this application further provides a communication device 3000, including a processor 3001 and a memory 3002. The memory 3002 stores a program or an instruction that can be run on the processor 3001. For example, when the communication device 3000 is a terminal, the program or the instruction is executed by the processor 3001 to implement the steps of the foregoing URSP rule monitoring and reporting method embodiment, and a same technical effect can be achieved. When the communication device 3000 is a network side device, the program or the instruction is executed by the processor 3001 to implement the steps of the foregoing URSP rule monitoring and reporting method embodiment, and a same technical effect can be achieved. To avoid repetition, details are not described herein again.

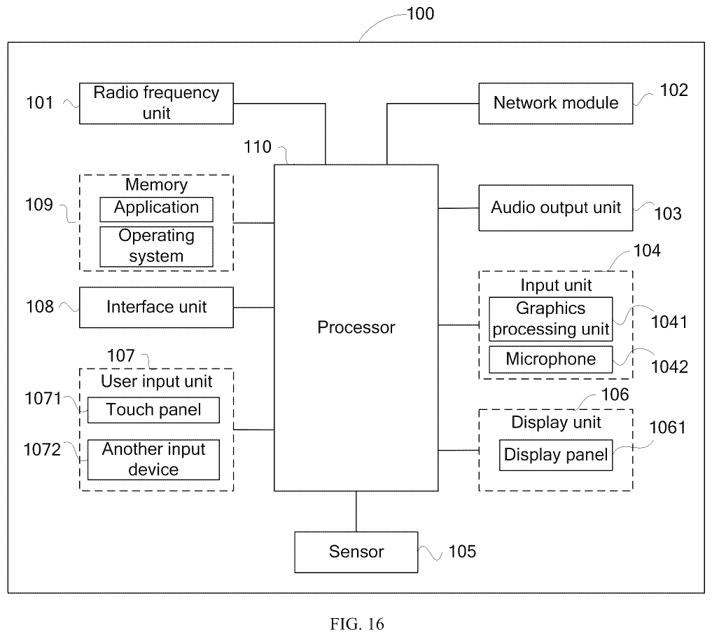

An embodiment of this application further provides a terminal, including a processor and a communication interface. The processor is configured to monitor evaluation result of a first URSP rule, and the communication interface is configured to send first information according to the evaluation result. This terminal embodiment corresponds to the foregoing method embodiment on the terminal side. Each implementation process and implementation of the foregoing method embodiment can be applied to this terminal embodiment, and a same technical effect can be achieved. FIG. 16 is a schematic structural diagram of hardware of a terminal according to an embodiment of this application.

A terminal 100 includes but is not limited to components such as a radio frequency unit 101, a network module 102, an audio output unit 103, an input unit 104, a sensor 105, a display unit 106, a user input unit 107, an interface unit 108, a memory 109, and a processor 110.

A person skilled in the art can understand that the terminal 100 may further include the power supply (for example, a battery) that supplies power to each component. The power supply may be logically connected to the processor 110 by using a power supply management system, so as to manage functions such as charging, discharging, and power consumption by using the power supply management system. The terminal structure shown in FIG. 16 constitutes no limitation on the terminal, and the terminal may include more or fewer components than those shown in the figure, or combine some components, or have different component arrangements. Details are not described herein.

It should be understood that, in this embodiment of this application, the input unit 104 may include a Graphics Processing Unit (GPU) 1041 and a microphone 1042, and the graphics processing unit 1041 processes image data of a still image or a video that is obtained by an image capturing apparatus (for example, a camera) in a video capturing mode or an image capturing mode. The display unit 106 may include a display panel 1061. The display panel 1061 may be configured in a form such as a liquid crystal display or an organic light-emitting diode. The user input unit 107 includes at least one of a touch panel 1071 and another input device 1072. The touch panel 1071 is also referred to as a touchscreen. The touch panel 1071 may include two parts: a touch detection apparatus and a touch controller. The another input device 1072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 101 may transmit the downlink data to the processor 110 for processing. In addition, the radio frequency unit 101 may send uplink data to the network side device. Usually, the radio frequency unit 101 includes but is not limited to an antenna, an amplifier, a transceiver, a coupler, a low noise amplifier, a duplexer, and the like.

The memory 109 may be configured to store a software program or an instruction and various data. The memory 109 may mainly include a first storage area for storing a program or an instruction and a second storage area for storing data. The first storage area may store an operating system, and an application or an instruction required by at least one function (for example, a sound playing function or an image playing function). In addition, the memory 109 may be a volatile memory or a non-volatile memory, or the memory 109 may include a volatile memory and a non-volatile memory. The nonvolatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch link DRAM (SLDRAM), and a Direct Rambus RAM (DRRAM). The memory 109 in this embodiment of this application includes but is not limited to these memories and a memory of any other proper type.

The processor 110 may include one or more processing units. In some embodiments, an application processor and a modem processor are integrated into the processor 110. The application processor mainly processes an operating system, a user interface, an application, and the like. The modem processor mainly processes a wireless communication signal, for example, a baseband processor. It can be understood that, the modem processor may not be integrated into the processor 110.

The processor 110 is configured to monitor evaluation result of a first URSP rule; and the radio frequency unit 101 is configured to send first information according to the evaluation result monitored by the monitoring module, where the first URSP rule includes at least one URSP rule in URSP rules in the terminal, and one URSP rule corresponds to one rule precedence; and the first information is used to indicate at least one of the following: whether the first URSP rule is evaluated by the terminal, related information of a first application, and a first packet data unit PDU session that application traffic of the first application matches, where the first application is an application for which the first URSP rule in the terminal is used when the first URSP rule is evaluated by the terminal.

In this embodiment of this application, the related information includes at least one of the following:
a traffic characteristic of the first application, where
the traffic characteristic includes at least one of the following: a traffic descriptor of the application traffic, a destination IP triplet of the application traffic, a fully qualified domain name FQDN of the application traffic, a data network name DNN of the application traffic, and a connection capability of the application traffic.

In this embodiment of this application, the first URSP rule includes at least one of the following:
a URSP rule corresponding to a first rule precedence in a plurality of URSP rules in the terminal;
a first traffic descriptor in the first rule precedence; and
a first route selection descriptor in the first rule precedence, where
the first rule precedence includes at least one rule precedence, and the first route selection descriptor includes at least one route selection descriptor in the first traffic descriptor.

In this embodiment of this application, the processor 110 is configured to: n a case that the application traffic of the first application in the terminal needs to be sent, match the application traffic according to the first URSP rule; and the processor 110 is further configured to: match the application traffic to the first PDU session, or establish a second PDU session that matches the application traffic; the radio frequency unit 101 is configured to: after the processor 110 matches the application traffic to the first PDU session or establishes the second PDU session that matches the application traffic, send the first information according to the evaluation result.

In this embodiment of this application, the first information includes at least one of the following:
traffic description information of the application traffic;
a URSP rule evaluated by the terminal;
a traffic descriptor selected by the terminal;
a route selection descriptor selected by the terminal;
a precedence of the traffic descriptor selected by the terminal;
a precedence of the route selection descriptor selected by the terminal;
a rule precedence selected by the terminal; and
PDU session information of a PDU session that carries the application traffic, where
the PDU session information includes at least one of the following: a PDU session attribute and a PDU session parameter, where the PDU session attribute includes at least one of the following: a session and service continuity mode, a data network name, a connection capability, single network slice selection assistance information, a PDU session type, an access type preference, and a PDU session identity ID.

In this embodiment of this application, the radio frequency unit 101 is configured to receive a first policy sent by a first network element, where the first network element includes a mobility management network element or a policy control network element; and the processor 110 is configured to: determine the first URSP rule according to the first policy received by the radio frequency unit 101, and monitor the evaluation result of the first URSP rule.

In this embodiment of this application, the first policy is used to indicate at least one of the following:
a URSP rule that needs to be monitored by the terminal;
a URSP rule corresponding to a first rule precedence that needs to be monitored by the terminal;
a first traffic descriptor that needs to be monitored by the terminal; and
a first route selection descriptor that needs to be monitored by the terminal.

In this embodiment of this application, the first traffic descriptor is a traffic descriptor in the first rule precedence; and the first route selection descriptor is a route selection descriptor in the first rule precedence, and the first rule precedence includes at least one rule precedence.

In this embodiment of this application, the radio frequency unit 101 is configured to send a registration request to a mobility management network element by using an uplink non-access stratum NAS message, where the registration request is used to request to deliver a first policy.

In this embodiment of this application, the registration request includes terminal capability information, and the terminal capability information is used to indicate that the terminal has a capability of monitoring evaluation result of a URSP rule.

In this embodiment of this application, the radio frequency unit 101 is configured to send the first information to a first network element according to the evaluation result, where the first network element includes a mobility management network element or a policy control network element.

According to the terminal provided in this embodiment of this application, a terminal monitors evaluation result of a first URSP rule, and sends first information according to the evaluation result, where the first URSP rule includes at least one URSP rule in URSP rules in the terminal, and one URSP rule corresponds to one rule precedence; and the first information is used to indicate at least one of the following: whether the first URSP rule is evaluated by the terminal, related information of a first application, and a first packet data unit PDU session that application traffic of the first application matches, where the first application is an application for which the first URSP rule in the terminal is used when the first URSP rule is evaluated by the terminal. In this method, the terminal may report the first information, to indicate whether the terminal executes the first URSP rule and a finally determined PDU session used to carry application traffic on the terminal. In this way, consistency of understanding between a terminal and a network side is ensured, thereby improving network reliability.

An embodiment of this application further provides a network side device, including a processor and a communication interface. This network side device embodiment corresponds to the foregoing method embodiment of the network side device. Each implementation process and implementation of the foregoing method embodiment can be applied to this network side device embodiment, and a same technical effect can be achieved.

In an example, the network side device is a policy control network element, and includes a processor and a communication interface. The communication interface is configured to obtain target information; and the processor is configured to determine, according to the target information, whether a terminal executes a first URSP rule, where the first URSP rule includes at least one URSP rule in URSP rules in the terminal, and one URSP rule corresponds to one rule precedence.

In an example, the network side device is a session management network element, including a processor and a communication interface. The communication interface is configured to send second information to a policy control network element, where the second information includes first attribute information of a target packet data unit PDU session that carries application traffic of a terminal, and the first attribute information is used by the policy control network element to determine whether the terminal executes a first URSP rule.

In an example, the network side device is a user plane management function network element, and includes a processor and a communication interface. The communication interface is configured to send a target session identifier of a target packet data unit PDU session to a session management network element, where the target PDU session is used to carry a first data packet of a first application, the first data packet is a data packet detected by a user plane management function network element by using a packet detection rule, the target session identifier is used by the session management network element to determine a target PDU session that carries application traffic of a terminal and first attribute information of the target PDU session, and the first attribute information is used by a policy control network element to determine whether the terminal executes a first URSP rule.

In an example, the network side device is a mobility management network element, including a processor and a communication interface. The communication interface is configured to receive an uplink non-access stratum NAS message sent by a terminal; and send a first policy to the terminal, where the uplink NAS message carries a registration request; and the registration request includes terminal capability information, and the terminal capability information is used to indicate that the terminal has a capability of monitoring evaluation result of a URSP rule.

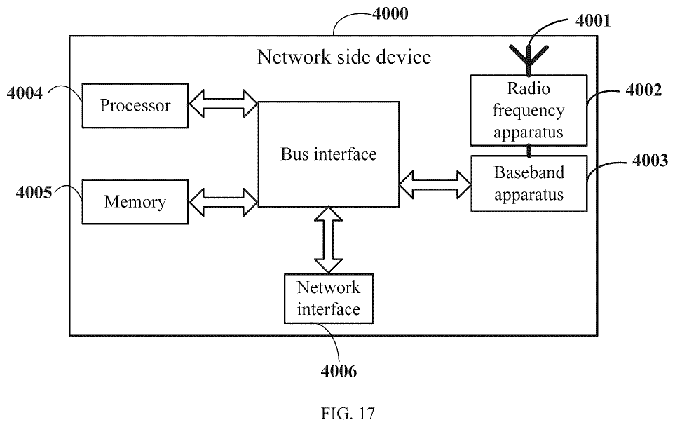

An embodiment of this application further provides a network side device. As shown in FIG. 17, the network side device 4000 includes an antenna 4001, a radio frequency apparatus 4002, a baseband apparatus 4003, a processor 4004, and a memory 4005. The antenna 4001 is connected to the radio frequency apparatus 4002. In an uplink direction, the radio frequency apparatus 4002 receives information through the antenna 4001, and sends the received information to the baseband apparatus 4003 for processing. In a downlink direction, the baseband apparatus 4003 processes information that needs to be sent, and sends processed information to the radio frequency apparatus 4002. The radio frequency apparatus 4002 processes the received information, and then sends processed information through the antenna 4001.

In the foregoing embodiment, the method performed by the network side device may be implemented in the baseband apparatus 4003. The baseband apparatus 4003 includes a baseband processor.

For example, the baseband apparatus 4003 may include at least one baseband board. A plurality of chips are disposed on the baseband board. As shown in FIG. 17, one chip is, for example, a baseband processor, and is connected to the memory 4005 by using a bus interface, to invoke a program in the memory 4005 to perform the operations of the network device shown in the foregoing method embodiment.

The network side device may further include a network interface 4006, and the interface is, for example, a common public radio interface (CPRI).

The network side device 4000 in this embodiment of the present application further includes an instruction or a program that is stored in the memory 4005 and that can be run on the processor 4004. The processor 4004 invokes the instruction or the program in the memory 4005 to perform the method performed by the modules shown in FIG. 17, and a same technical effect is achieved. To avoid repetition, details are not described herein again.

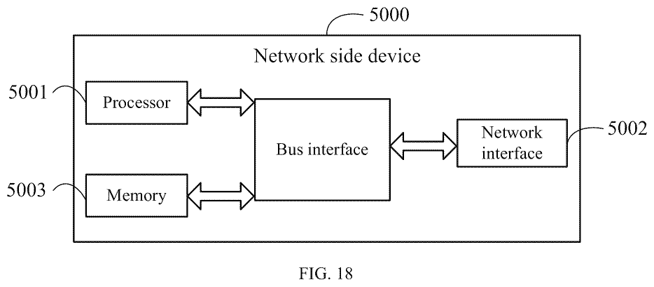

An embodiment of this application further provides a network side device. As shown in FIG. 18, the network side device 5000 includes a processor 5001, a network interface 5002, and a memory 5003. The network interface 5002 is, for example, a common public radio interface (CPRI).

The network side device 5000 in this embodiment of the present application further includes an instruction or a program that is stored in the memory 5003 and that can be run on the processor 5001. The processor 5001 invokes the instruction or the program in the memory 5003 to perform the method performed by the modules shown in any one of FIG. 11 to FIG. 14, and a same technical effect is achieved. To avoid repetition, details are not described herein again.

An embodiment of this application further provides a readable storage medium. The readable storage medium stores a program or an instruction, and the program or the instruction is executed by a processor to implement the processes of the foregoing URSP rule monitoring and reporting method embodiment, and a same technical effect can be achieved. To avoid repetition, details are not described herein again.

The processor is a processor in the terminal in the foregoing embodiment. The readable storage medium includes a computer readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or an instruction to implement the processes of the foregoing URSP rule monitoring and reporting method embodiment, and a same technical effect can be achieved. To avoid repetition, details are not described herein again.

It should be understood that the chip mentioned in this embodiment of this application may also be referred to as a system-level chip, a system chip, a chip system, or an on-chip system chip.

An embodiment of this application further provides a computer program/program product. The computer program/program product is stored in a storage medium, and the computer program/program product is executed by at least one processor to implement the processes of the foregoing URSP rule monitoring and reporting method embodiment, and a same technical effect can be achieved. To avoid repetition, details are not described herein again.

An embodiment of this application further provides a communication system, including a terminal and a network side device. The terminal may be configured to perform the steps of the foregoing URSP rule monitoring and reporting method, and the network side device may be configured to perform the steps of the foregoing URSP rule monitoring and reporting method.

It should be noted that, in this specification, the terms “include”, “comprise”, or their any other variant are intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element preceded by “includes a . . . ” does not, without more constraints, preclude the presence of additional identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the foregoing descriptions of the embodiments, a person skilled in the art may clearly understand that the method in the foregoing embodiment may be implemented by software in addition to a necessary universal hardware platform or by hardware only. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the above specific implementations, and the above specific implementations are merely illustrative but not restrictive. Under the enlightenment of this application, a person of ordinary skill in the art can make many forms without departing from the purpose of this application and the protection scope of the claims, all of which fall within the protection of this application.

1. A method for UE route selection policy (URSP) rule monitoring and reporting, comprising:
monitoring, by a terminal, evaluation result of a first URSP rule; and
sending, by the terminal, first information according to the evaluation result,
wherein the first information is used to indicate at least one of the following: whether the first URSP rule is evaluated by the terminal, related information of a first application, or a first packet data unit (PDU) session that application traffic of the first application matches, wherein the application traffic of the first application is application traffic for which the first URSP rule is used when the first URSP rule is evaluated by the terminal.

2. The method according to claim 1, wherein the related information comprises:
a traffic characteristic of the application traffic of the first application,
wherein the traffic characteristic comprises at least one of the following: a traffic descriptor of the application traffic, a destination IP triplet to which the application traffic is sent, a fully qualified domain name (FQDN) of the application traffic, a data network name (DNN) to which the application traffic is sent, and a connection capability of the application traffic.

3. The method according to claim 1, wherein the first URSP rule comprises at least one of the following:
a URSP rule corresponding to a first rule precedence in a plurality of URSP rules in the terminal;
a first traffic descriptor in the first rule precedence; or
a first route selection descriptor in the first rule precedence,
wherein the first rule precedence comprises at least one rule precedence, and the first route selection descriptor comprises at least one route selection descriptor in the first traffic descriptor.

4. The method according to claim 1, wherein:
before the sending, by the terminal, first information according to the evaluation result, the method further comprises:
when the application traffic of the first application in the terminal needs to be sent, matching, by the terminal, the application traffic according to the first URSP rule; and
matching, by the terminal, the application traffic to the first PDU session, or establishing a second PDU session that matches the application traffic; and
the sending, by the terminal, first information according to the evaluation result comprises:
after matching the application traffic to the first PDU session or establishing the second PDU session that matches the application traffic, sending, by the terminal, the first information according to the evaluation result.

5. The method according to claim 1, wherein the first information comprises at least one of the following:
traffic description information of the application traffic;
a URSP rule evaluated by the terminal;
a traffic descriptor selected by the terminal;
a route selection descriptor selected by the terminal;
a precedence of the traffic descriptor selected by the terminal;
a precedence of the route selection descriptor selected by the terminal;
a rule precedence selected by the terminal; or
PDU session information of a PDU session that carries the application traffic,
wherein the PDU session information comprises at least one of the following: a session and service continuity mode, a data network name, a connection capability, single network slice selection assistance information, a PDU session type, an access type preference, or a PDU session identity (ID).

6. The method according to claim 1, wherein:
before the monitoring, by a terminal, evaluation result of a first URSP rule, the method further comprises:
receiving, by the terminal, a first policy sent by a first network element, wherein the first network element comprises a mobility management network element or a policy control network element; and
the monitoring, by a terminal, evaluation result of a first URSP rule comprises:
determining, by the terminal, the first URSP rule according to the first policy, and monitoring the evaluation result of the first URSP rule.

7. The method according to claim 6, wherein the first policy is used to indicate at least one of the following:
a URSP rule that needs to be monitored by the terminal;
a URSP rule corresponding to a first rule precedence that needs to be monitored by the terminal;
a first traffic descriptor that needs to be monitored by the terminal; or
a first route selection descriptor that needs to be monitored by the terminal.

8. The method according to claim 7, wherein the first traffic descriptor is a traffic descriptor in the first rule precedence; and the first route selection descriptor is a route selection descriptor in the first rule precedence, and the first rule precedence comprises at least one rule precedence.

9. The method according to claim 1, wherein before the monitoring, by a terminal, evaluation result of a first URSP rule, the method further comprises:
sending, by the terminal, a registration request to a mobility management network element by using an uplink non-access stratum (NAS) message, wherein the registration request is used to request to deliver a first policy.

10. The method according to claim 9, wherein the registration request comprises terminal capability information, and the terminal capability information is used to indicate that the terminal has a capability of monitoring evaluation result of a URSP rule.

11. The method according to claim 1, wherein the sending, by the terminal, first information according to the evaluation result comprises:
sending, by the terminal, the first information to a first network element according to the evaluation result, wherein the first network element comprises a mobility management network element or a policy control network element.

12. A method for UE route selection policy (URSP) rule monitoring and reporting, comprising:
receiving, by a mobility management network element, an uplink non-access stratum (NAS) message sent by a terminal; and
sending, by the mobility management network element, a first policy to the terminal,
wherein the uplink NAS message carries a registration request, the registration request comprises terminal capability information, and the terminal capability information is used to indicate that the terminal has a capability of monitoring evaluation result of a URSP rule.

13. The method according to claim 12, wherein the first policy is used to indicate at least one of the following:
a URSP rule that needs to be monitored by the terminal;
a URSP rule corresponding to a first rule precedence that needs to be monitored by the terminal;
a first traffic descriptor that needs to be monitored by the terminal; or
a first route selection descriptor that needs to be monitored by the terminal.

14. A terminal, comprising: a memory storing a computer program; and a processor coupled to the memory and configured to execute the computer program to perform operations comprising:
monitoring evaluation result of a first UE route selection policy (URSP) rule; and
sending first information according to the evaluation result,
wherein the first information is used to indicate at least one of the following: whether the first URSP rule is evaluated by the terminal, related information of a first application, or a first packet data unit (PDU) session that application traffic of the first application matches, wherein the application traffic of the first application is application traffic for which the first URSP rule is used when the first URSP rule is evaluated by the terminal.

15. The terminal according to claim 14, wherein the related information comprises:
a traffic characteristic of the application traffic of the first application,
wherein the traffic characteristic comprises at least one of the following: a traffic descriptor of the application traffic, a destination IP triplet to which the application traffic is sent, a fully qualified domain name (FQDN) of the application traffic, a data network name (DNN) to which the application traffic is sent, and a connection capability of the application traffic.

16. The terminal according to claim 14, wherein the first URSP rule comprises at least one of the following:
a URSP rule corresponding to a first rule precedence in a plurality of URSP rules in the terminal;
a first traffic descriptor in the first rule precedence; or
a first route selection descriptor in the first rule precedence,
wherein the first rule precedence comprises at least one rule precedence, and the first route selection descriptor comprises at least one route selection descriptor in the first traffic descriptor.

17. The terminal according to claim 14, wherein:
before the sending first information according to the evaluation result, the operations further comprise:
when the application traffic of the first application in the terminal needs to be sent, matching the application traffic according to the first URSP rule; and
matching the application traffic to the first PDU session, or establishing a second PDU session that matches the application traffic; and
the sending first information according to the evaluation result comprises:
after matching the application traffic to the first PDU session or establishing the second PDU session that matches the application traffic, sending the first information according to the evaluation result.

18. The terminal according to claim 14, wherein the first information comprises at least one of the following:
traffic description information of the application traffic;
a URSP rule evaluated by the terminal;
a traffic descriptor selected by the terminal;
a route selection descriptor selected by the terminal;
a precedence of the traffic descriptor selected by the terminal;
a precedence of the route selection descriptor selected by the terminal;
a rule precedence selected by the terminal; or
PDU session information of a PDU session that carries the application traffic,
wherein the PDU session information comprises at least one of the following: a session and service continuity mode, a data network name, a connection capability, single network slice selection assistance information, a PDU session type, an access type preference, or a PDU session identity (ID).

19. The terminal according to claim 14, wherein:
before the monitoring evaluation result of a first URSP rule, the operations further comprise:
receiving a first policy sent by a first network element, wherein the first network element comprises a mobility management network element or a policy control network element; and
the monitoring evaluation result of a first URSP rule comprises:
determining the first URSP rule according to the first policy, and monitoring the evaluation result of the first URSP rule.

20. The terminal according to claim 19, wherein the first policy is used to indicate at least one of the following:
a URSP rule that needs to be monitored by the terminal;
a URSP rule corresponding to a first rule precedence that needs to be monitored by the terminal;
a first traffic descriptor that needs to be monitored by the terminal; or
a first route selection descriptor that needs to be monitored by the terminal.
